(19) United States
(12) Patent Application Publication
(10) Pub. No.: US 2026/0153926 A1
(43) Pub. Date: Jun. 4, 2026

(54) INFORMATION PROCESSING DEVICE AND INFORMATION PROCESSING METHOD

(71) Applicant: Sony Interactive Entertainment Inc., Tokyo (JP)

(72) Inventors: Kenichi Morimura, Tokyo (JP); Yoichi Nishimaki, Kanagawa (JP)

(73) Assignee: Sony Interactive Entertainment Inc., Tokyo (JP)

(21) Appl. No.: 19/429,740

(22) Filed: Dec. 22, 2025

Related U.S. Application Data
(63) Continuation of application No. PCT/JP2024/009096, filed on Mar. 8, 2024.

(30) Foreign Application Priority Data
Jul. 3, 2023 (JP) 2023-109636

(51) Int. Cl. G06F 3/01

(52) U.S. Cl. CPC G06F 3/013

(57) ABSTRACT

An information processing device and method for identifying a target aligned with a line of sight of a user as a selection target are disclosed. An example information processing device includes one or more storage devices storing instructions and one or more processors. Upon execution of the instructions, the one or more processors: acquire information on a line of sight vector of the user; detect a selection candidate based on a positional relationship between the line of sight vector and the target; and determine whether to make the selection candidate a selection target based on conditions according to a selection situation at the time the selection candidate is detected.

### CROSS-REFERENCE TO RELATED APPLICATIONS

This application is a Continuation Application under 35 U. S. C. 111 of International Application no. PCT/JP2024/009096, filed on Mar. 8, 2024, and Japanese patent application 2023-109636, filed on Jul. 3, 2023, the entire disclosure of which is incorporated herein by reference for all purposes.

### TECHNICAL FIELD

The present disclosure relates to an information processing device and an information processing method that accept a selection operation by a user.

### BACKGROUND ART

Art for tracking the line of sight movement of a user looking at a display screen or the real world and allowing objects or real things in front of the line of sight to be selection targets or to be operated by the line of sight movement is known. See, for example, JP 2016-181302 A and JP 2022-87721 A). This makes it easier to select objects in the virtual world that cannot actually be touched, and enables the manipulation of distant objects in the real world without using one's hands.

### SUMMARY

Whether in the image world or the real world, the accuracy of selecting a target by line of sight is affected by various factors, such as whether the selection candidate is in a situation where it is easy to align the line of sight, the accuracy of line of sight detection, the user's personal characteristics, and the algorithm used to determine the selection. This can cause a great deal of stress to the user when a different target than intended is selected or when the user is unable to select a target. This problem becomes more severe when the selection target is moving or has a non-uniform apparent size.

The present disclosure has been configured in view of these problems, and an object thereof is to provide art that improves the robustness of the accuracy of selecting a target by line of sight and realizes easy selection.

In order to solve the foregoing problems, one embodiment of the present disclosure relates to an information processing device. This information processing device is an information processing device for identifying a selection target on which the user's line of sight is aligned as a selection target, provided with: a line of sight information acquisition unit for acquiring information on a line of sight vector of the user; a hit determination unit for detecting a selection candidate based on a positional relationship between the line of sight vector and the selection target; and a selection determination unit for determining whether to make the selection candidate a selection target based on conditions according to a selection situation at the time the selection candidate is detected.

Another aspect of the present disclosure relates to an information processing method. This information processing method is an information processing method for identifying a selection target on which the user's line of sight is aligned as a selection target, including: a step for acquiring information on a line of sight vector of the user; a step for detecting a selection candidate based on a positional relationship between the line of sight vector and the selection target; and a step for determining whether to make the selection candidate a selection target based on conditions according to a selection situation at the time the selection candidate is detected.

Note that any combination of the above constituent elements, and conversion of an expression of the present disclosure into a method, apparatus, system, computer program, data structure, recording medium, or the like, are also valid aspects of the present disclosure.

According to the present disclosure, the robustness of the accuracy of selecting a target by line of sight can be improved, and easy selection can be realized.

### BRIEF DESCRIPTION OF DRAWINGS

FIG. 1 is a diagram for describing an example of a configuration of a system to which the present embodiment can be applied.

FIG. 2 is a diagram illustrating an internal circuit configuration of the information processing device according to the present embodiment.

FIG. 3 is a diagram illustrating a configuration of functional blocks of the information processing device according to the present embodiment.

FIG. 4 is a flowchart illustrating an outline of a processing procedure in which a selection target determination unit of the information processing device determines a selection target in the present embodiment.

FIG. 5 is a flowchart illustrating a processing procedure in which a hit determination unit performs hit determination in S16 of FIG. 4.

FIG. 6 is a diagram illustrating a schematic view of the manner in which the hit determination unit performs hit determination in S32 and S36 of FIG. 5.

FIG. 7 is a diagram illustrating an example of rules for determining an angle from a line of sight vector, which is used by a hit determination unit to set a margin region in the present embodiment.

FIG. 8 is a diagram for describing an example of a technique in which a hit determination unit performs hit determination using a margin region in the present embodiment.

FIG. 9 is a diagram for describing another example of a technique in which a hit determination unit performs hit determination using a margin region in the present embodiment.

FIG. 10 is a diagram for describing how a difference in apparent size of objects affects a selection target determination process when the objects appear to overlap in the present embodiment.

FIG. 11 is a diagram illustrating a technique for dividing an object via the hit determination unit in the present embodiment.

FIG. 12 is a diagram for describing the conditions for the hit determination unit to divide an object from the relationship with the line of sight vector in the present embodiment.

FIG. 13 is a diagram illustrating an example in which combinations of objects of various shapes are classified according to division necessity in the present embodiment.

FIG. 14 is a diagram for describing an example of a technique for determining division necessity based on a shape of an object in the present embodiment.

FIG. 15 is a diagram for describing an aspect in which the hit determination unit limits a range for dividing the object in the present embodiment.

FIG. 16 is a diagram for describing an example of division rules that take into account a case where a surface of an object is tilted with respect to the viewpoint in the present embodiment.

FIG. 17 is a diagram for describing another example of division rules that take into account a case where a surface of an object is tilted with respect to the viewpoint in the present embodiment.

FIG. 18 is a diagram schematically illustrating, in S52 of FIG. 5, the hit determination unit determining the hit object using the gaze point distance.

FIG. 19 is a diagram illustrating variation of the margin region set by the hit determination unit in the present embodiment.

FIG. 20 is a diagram for describing a technique for detecting a hit object based on a correlation between a line of sight vector and movement of the object in the present embodiment.

FIG. 21 is a diagram for describing a time relationship between a detected line of sight vector and an image world in the present embodiment.

FIG. 22 is a flowchart illustrating a processing procedure in which the selection determination unit determines a selection target in S18 of FIG. 4.

FIG. 23 is a flowchart illustrating a processing procedure in which the selection determination unit determines a selection target in S18 of FIG. 4.

FIG. 24 is a diagram schematically illustrating a state of the selection determination unit comparing the distance between the line of sight vector and the object in S78 of FIG. 23.

FIG. 25 is a diagram illustrating an example of a change in distance data due to a smoothing filter in the present embodiment.

FIG. 26 is a diagram for describing a division condition required when the positional relationship and size of the objects diversify in the present embodiment.

FIG. 27 is a diagram schematically illustrating an example of an object in which a plurality of OBBs are set for one object in the present embodiment.

FIG. 28 is a diagram for describing a basic procedure for the hit determination unit to determine the necessity of division in a case where a plurality of OBBs are defined for one object is allowed in the present embodiment.

FIG. 29 is a flowchart illustrating a processing procedure in which the hit determination unit determines division necessity in the present embodiment.

FIG. 30 is a flowchart illustrating a processing procedure in which the hit determination unit determines division necessity in the present embodiment.

FIG. 31 is a diagram illustrating an example of a case in which the first division candidate is set as the division target in S112 of the flowchart of FIG. 30.

FIG. 32 is a diagram illustrating an example of a case in which the second division candidate is set as the division target in S116 of the flowchart of FIG. 30.

FIG. 33 is a diagram illustrating an example of a case in which the first division candidate is set as the division target due to comparison to a second reference OBB in S120 of the flowchart of FIG. 30.

FIG. 34 is a diagram for describing a variation of a technique for estimating the size and shape of an object in the present embodiment.

FIG. 35 is a diagram for describing a technique for projecting a division target surface onto a projection plane and then dividing in the present embodiment.

FIG. 36 is a diagram for describing a technique for acquiring a history of distance values for each partial object in an aspect of dividing objects on a projection plane in the present embodiment.

FIG. 37 is a diagram illustrating an example of a case where another object is set as the hit object even when the user tries to align the line of sight.

FIG. 38 is a diagram comparing a selection procedure of objects when a detection process of a deemed hit object is not introduced and when such is introduced in the present embodiment.

FIG. 39 is a flowchart illustrating a processing procedure in which the hit determination unit detects the deemed hit object in the present embodiment.

FIG. 40 is a flowchart illustrating a processing procedure in which the hit determination unit selects the final hit object when the deemed hit object is detected in the present embodiment.

FIG. 41 is a diagram for describing a principle for quantifying a difficulty of tracking a deemed hit object, which is checked in S158 of the flowchart of FIG. 40.

FIG. 42 is a diagram for describing a calculation technique for a parameter representing a difficulty in tracking a deemed hit object in the present embodiment.

### DETAILED DESCRIPTION

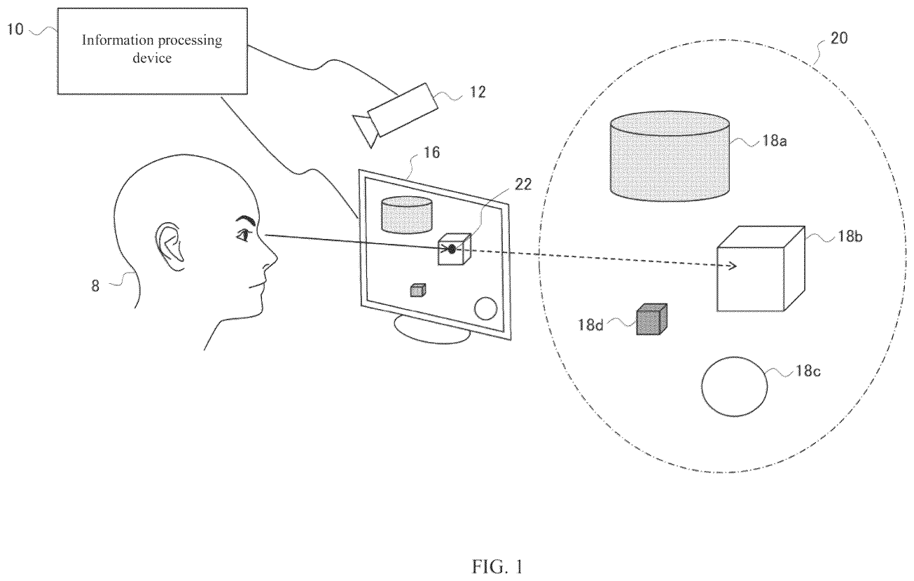

FIG. 1 is a diagram for describing an example of a configuration of a system to which the present embodiment can be applied. The present embodiment relates to art in which a user performs a selection operation on a target by aligning their line of sight (gazing) on the target. In the illustrated example, an information processing system is composed of an information processing device 10, a line of sight detector 12, and a display device 16. The line of sight detector 12 acquires a line of sight vector of a user 8 looking at a screen of the display device 16 at a predetermined rate. The information processing device 10 displays an image on the display device 16 and identifies a target on the image to which the user has aligned their line of sight based on the detection result of the line of sight vector by the line of sight detector 12.

In this example, images of objects 18a, 18b, 18c, and 18d present in a three-dimensional image world 20 are displayed on the display device 16. When the user 8 aligns their line of sight on one of them, the information processing device 10 identifies the image on the screen that the user 8 is gazing at based on the detection result of the line of sight vector, and determines that the corresponding object (for example, object 18b) has been selected. The information processing device 10 processes the determination result as input information and reflects it in the display image as appropriate.

Here, the information processing performed by the information processing device 10 and the type and purpose of the display image generated are not particularly limited. For example, the information processing device 10 may construct the image world 20 as a stage for an electronic game and place and move the objects 18a, 18b, 18c, and 18d as enemy characters. In this case, for example, a game or the like can be realized in which the user 8, who is the player, aims at an enemy character with their line of sight and shoots by pulling a trigger using an input device that is not illustrated. The information processing device 10 may display a cursor 22 at a position where the line of sight of the user 8 intersects with the display screen, or the like, and thus the user 8 can recognize where the line of sight hits.

The line of sight detector 12 is composed of, for example, a reference light irradiating unit such as an infrared LED, an imaging unit such as an infrared camera or a PSD (Position Sensitive Detector) sensor, and an analyzing unit such as a processor. In the line of sight detector 12, the reference light irradiating unit irradiates the left and right eyes of the user 8 with reference light, and the image capturing unit captures reflected light thereof.

The analysis unit identifies the reflection position of the reference light on the cornea and the position of the pupil from the image, and identifies the user's line of sight from the positional relationship thereof. This technique has been put to practical use as the corneal reflection method in the field of line of sight detection art. However, the technique for detecting the line of sight is not limited to this, and any common technique may be used, such as art for photographing the left and right eyes using a visible light camera and identifying the line of sight from the relative positions of the inner corners of the eyes and the irises in the captured image.

The scope of application of the present embodiment is not limited to that illustrated in the drawing, and it will be understood by those skilled in the art that various configurations thereof are conceivable as long as the user's line of sight is detected and information processing is performed using this as input information. For example, the target of line of sight alignment is not limited to an object displayed as an image on the display device 16, but may be an object that exists in the real world. In this case, by introducing a monocular camera or stereo camera to capture the real world and performing appropriate coordinate transformation so that the captured real object is present in the same coordinate system as the line of sight vector, it is possible to construct a space using real objects that is similar to the image world described below.

When making a selection on a displayed image, the selection target is not limited to an image of an object having a three-dimensional model as illustrated in the drawing, but may be a character string, a figure, a photograph, a picture, or the like. Furthermore, the display form is not limited, and in addition to the flat display device 16 illustrated in the drawing, it may be a projector, or a wearable display such as a head-mounted display or smart glasses.

The shapes, positional relationship, and connection relationship of the information processing device 10, the line of sight detector 12, and the display device 16 are not limited. For example, when the display device 16 is a wearable display, the line of sight detector 12 may be provided in the wearable display. The information processing system may also be realized by a tablet terminal, a game console, a high-performance mobile phone, or the like that is integrally equipped with the information processing device 10, the line of sight detector 12, and the display device 16.

Introducing line of sight as selection means increases variation in user interfaces and also enables intuitive operation. Conversely, when an item different from the intended one is selected or when the selection cannot be made for a long time due to various factors such as those listed below, this can cause great stress to the user.
1. Due to the accuracy of the line of sight detector and instability of line of sight, the selection may unintentionally be lost or switched frequently.
2. When the selection target moves, the line of sight may not be able to follow or may be off target.
3. Multiple selection targets overlap, making it difficult to align the line of sight
4. The apparent sizes of selection targets create a difference in the ease of selection

Therefore, in the present embodiment, the process of detecting an object whose line of sight is in align and the process of determining the detected object as the selection target are adjusted and determined according to various situations, thereby enabling the desired selection target with stable accuracy. Hereinafter, the former detection process may be referred to as “hit determination,” and the latter determination process may be referred to as “selection determination.”

When the display device 16 is a head-mounted display or the like and stereoscopic vision is realized by displaying images for the left eye and the right eye with parallax, the line of sight detector 12 may have a function to estimate a gaze point distance. A characteristic of the human eye is that the pupils of both eyes converge and diverge when the object being gazed upon is close, and open outward when the object is far away. Using this, a technique is known in which the line of sight vectors of the left and right eyes are acquired and the distance to the point where they intersect is estimated as the gaze point distance (for example, see JP 2000-13818 A).

According to this art, it is possible to acquire a three-dimensional gaze point including the distance from the viewpoint, and thus it is possible to identify the target that the user is gazing at, for example, based on the three-dimensional position coordinates of the object in the image world. This technique can also be applied to selecting real objects in the real world. Note that in the following description, stereoscopic viewing of objects having three-dimensional models placed in the three-dimensional image world 20 will mainly be described, but as described above, this is not intended to limit the selection targets of the present embodiment thereto.

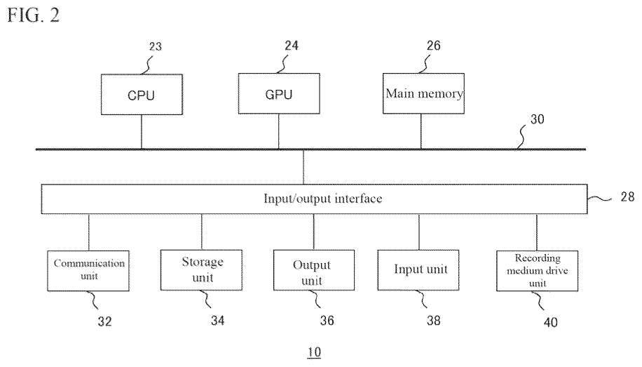

FIG. 2 illustrates the internal circuit configuration of the information processing device 10. The information processing device 10 includes a CPU (Central Processing Unit) 23, a GPU (Graphics Processing Unit) 24, and a main memory 26. These components are connected to each other via a bus 30. An input/output interface 28 is further connected to the bus 30.

The input/output interface 28 is connected to a communication unit 32 that establishes communication with a server, or the like, a storage unit 34 such as a hard disk drive or non-volatile memory, an output unit 36 for outputting image data to the display device 16, an input unit 38 for inputting data from the line of sight detector 12, and a recording medium drive unit 40 for driving a removable recording medium such as a magnetic disk, optical disk, or semiconductor memory. The communication unit 32 realizes communication using known wireless communication art such as Bluetooth (registered trademark) or wired communication art.

The CPU 23 controls the entire Information processing device 10 by running an operating system stored in the storage unit 34. The CPU 23 also executes various programs that are read from the removable recording medium and loaded into the main memory 26 or downloaded via the communication unit 32. The GPU 24 has a geometry engine function and a rendering processor function, performs drawing processing in accordance with drawing commands from the CPU 23, and outputs the results to the output unit 36. The main memory 26 is constituted by RAM (Random Access Memory) and stores programs or data necessary for processing.

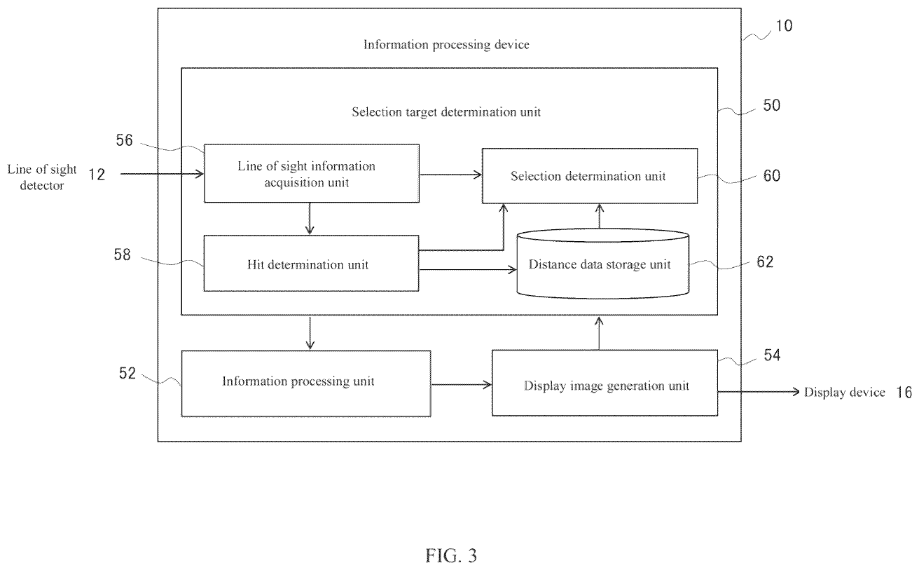

FIG. 3 illustrates a configuration of functional blocks of the information processing device 10. The illustrated functional blocks can be realized in terms of hardware by the circuit configuration illustrated in FIG. 2, and in terms of software by programs that are loaded from the storage unit 34 into the main memory 26 and perform various functions such as a data input function, a data holding function, an image processing function, and a communication function. Therefore, it will be understood by those skilled in the art that these functional blocks can be realized in various forms using only hardware, only software, or a combination thereof, and the present disclosure is not limited to any of these.

The information processing device 10 includes a selection target determination unit 50 for determining a selection target based on line of sight information, an information processing unit 52 for performing information processing based on the determined selection target, and a display image generation unit 54 for generating a display image as a result of the information processing. In detail, the selection target determination unit 50 includes a line of sight information acquisition unit 56, a hit determination unit 58, a selection determination unit 60, and a distance data storage unit 62. The line of sight information acquisition unit 56 acquires information on the line of sight vector of the user with respect to the image displayed on the display device 16 from the line of sight detector 12 at a predetermined rate.

Each time the line of sight information acquisition unit 56 acquires line of sight vector information, the hit determination unit 58 calculates the distance between each selection candidate object (hereinafter simply referred to as an “object”) illustrated in the displayed image and the line of sight vector, and stores the distance in the distance data storage unit 62. The hit determination unit 58 also performs hit determination to detect, as a selection candidate, an object with which the line of sight is in contact among the objects.

At this time, the hit determination unit 58 sets a margin region that includes the line of sight vector and has a predetermined angle range when viewed from the viewpoint, and detects an object that can be considered to have line of sight based on the positional relationship with the object. For example, the hit determination unit 58 detects an object of which at least a part is within the margin region. This makes it possible to detect an object that can be considered to be in line of sight even when the lines of sight are not exactly aligned. The hit determination unit 58 supplies information on the object that is deemed to be in line of sight (hereinafter referred to as the “hit object”) to the selection determination unit 60.

When there is an object that is clearly larger than nearby objects, the hit determination unit 58 divides the object under predetermined conditions. Here, division means that an object whose three-dimensional model has been acquired is (virtually) subdivided in a computational manner. The distance to the line of sight vector is then recalculated in those units and stored in the distance data storage unit 62. The hit determination unit 58 then performs hit determination again for each divided unit in the same manner as described above. This division process prevents differences in the ease of selection due to differences in object size.

The selection determination unit 60 determines whether to make a new hit object a selection target based on conditions according to the selection situation at the time when the hit determination is made. The selection status here may include whether there is already a currently selected object, as well as the persistence time of the state in which the hit object is not a selection target, and the like. Qualitatively, even when a new hit object is detected, the selection determination unit 60 does not allow the object that was previously the selection target to be switched unless the temporal or positional predominance is high. Here, temporal predominance refers to the length of time that the line of sight is held, and positional predominance refers to proximity from the line of sight vector.

This makes it less likely that the selection target will be unintentionally switched to another object, or that switching will be repeated in a short period of time. The selection determination unit 60 reads data on the distances from the line of sight vectors of the currently selected object and the new hit object from the distance data storage unit 62 and compares them to determine the positional predominance. At this time, the selection determination unit 60 applies a smoothing filter to the original distance value before making a comparison, thereby increasing the robustness of the selection accuracy against blurring of the line of sight vector detection result or the line of sight itself.

The distance data storage unit 62 stores the identification information of each object and the distance from the line of sight vector of the object in association with each other. The distance between the object and the line of sight vector naturally changes as they move. The distance data storage unit 62 accumulates and stores distance values acquired at least within the most recent predetermined time period. The selection determination unit 60 performs filtering using the history of distance values thus accumulated, and uses the results for distance comparison when determining a selection target.

The information processing unit 52 performs information processing using the selection target determination result by the selection target determination unit 50 as input information. As described above, the content of the information processing performed by the information processing unit 52 is not particularly limited. The information processing unit 52 may perform information processing by combining a user operation on an input device, such as a controller that is not illustrated, with the result of selection target determination by the selection target determination unit 50.
the display image generation unit 54 generates an image to be displayed as a result of the information processing by the information processing unit 52 at a predetermined rate. The display image generation unit 54 sequentially outputs the generated display image data to the display device 16 for display. The selection target determining unit 50 may be separated from the information processing unit 52 and the display image generation unit 54 and realized as an input device using a line of sight.

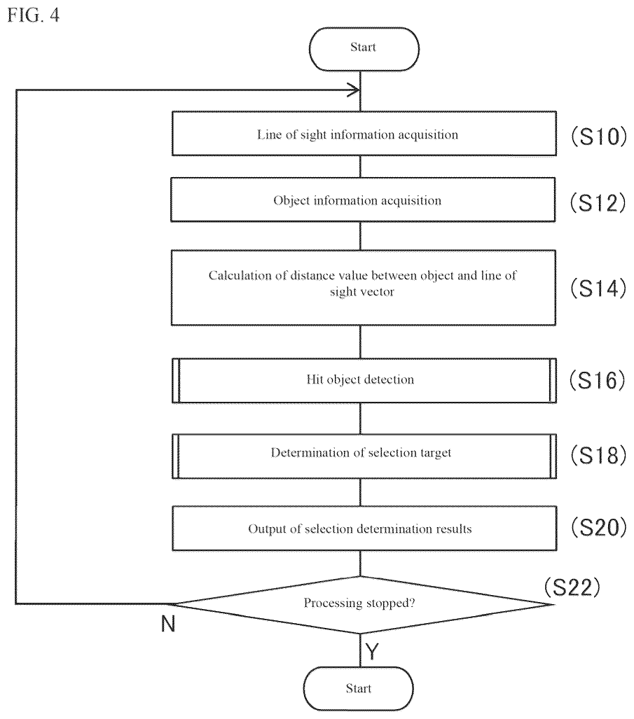

FIG. 4 is a flowchart illustrating an outline of a processing procedure in which the selection target determination unit 50 of the information processing device 10 determines a selection target. This flowchart is executed in a state where the information processing unit 52 performs information processing and the image generated by the display image generation unit 54 in response to the information processing is displayed on the display device 16. First, the line of sight information acquisition unit 56 acquires information relating to the line of sight vector of the user from the line of sight detector 12 (S10).

Conversely, the hit determination unit 58 acquires information about the shape and position of the object from the information processing unit 52 or the display image generation unit 54 (S12). When the display target is defined in a three-dimensional space, the shape and position coordinates of the object is three-dimensional information. Then, the hit determination unit 58 virtually places the line of sight vector acquired in S10 in the three-dimensional space of the display target, and calculates the distance between each object and the line of sight vector (S14).

The distance may be a relative value for comparison, and thus the hit determination unit 58 may, for example, project the object and the line of sight vector onto a predetermined plane and calculate the distance by two-dimensional calculation. Note that when the object is originally defined two-dimensionally, the distance between the object and the point where the line of sight vectors intersect on the image plane can be found. The hit determination unit 58 stores the distance value acquired for each object in the distance data storage unit 62 in association with the object's identification information.

Next, the hit determination unit 58 detects an object that can be considered to be in line of sight as a hit object (S16). That is, the hit determination unit 58 extracts objects that are reached by the line of sight vector or objects at least a part of which is within the margin region. In practice, the processes of S12 and S14 may be performed simultaneously. That is, the hit determination unit 58 may project the object, the line of sight vector, and the surrounding margin region onto a predetermined plane, and on that plane, acquire the distance for each object and determine whether it is inside or outside the margin region.

Alternatively, the hit determination unit 58 may apply a ray tracing technique in the art of computer graphics to detect an object at the destination of the line of sight vector and acquire the distance to the object. Furthermore, in the process of S16, the hit determination unit 58 may divide the object as described above, acquire the distance value from the line of sight vector in each division, and further perform hit determination. The hit determination unit 58 supplies information on the detected hit object to the selection determination unit 60. When a hit object is not detected, the hit determination unit 58 supplies this to the selection determination unit 60.
the selection determination unit 60 determines the selection target based on the result of the hit determination by the hit determination unit 58 (S18). The details determined by the selection determination unit 60 here may include not only whether to switch the currently selected object to another hit object, but also whether to remove the currently selected object from the selection target when there is no hit object, and whether to select a new hit object when there is no currently selected object.

The selection determination unit 60 outputs the determined contents to the information processing unit 52 (S20). The information processing unit 52 and the display image generation unit 54 perform information processing based on the determined content, and output a display image to the display device 16. When there is no need to stop the selection process based on the line of sight due to the end of information processing or the like (N in S22), the selection target determination unit 50 will repeat the processes of S10 to S20 at a predetermined rate. When it becomes necessary to stop the selection process based on the line of sight, the selection target determination unit 50 ends all the processes (Y in S22).

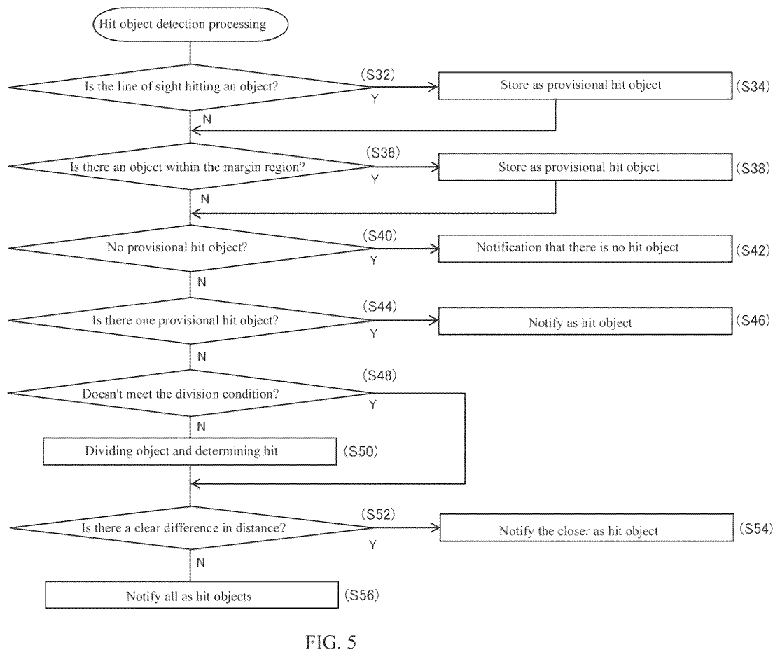

FIG. 5 is a flowchart illustrating a processing procedure in which the hit determination unit 58 performs hit determination in S16 of FIG. 4. The hit determination unit 58 checks whether the line of sight vector passes through any object, that is, whether it hits any object (S32). When there is an object that is being hit by the line of sight (Y in S32), the hit determination unit 58 temporarily stores the object in an internal memory or the like as a provisional hit object (S34).

When the line of sight vector does not hit any object (N in S32), or after temporarily storing the provisional hit object in S34, the hit determination unit 58 further checks whether there is an object at least partially within the margin region centered on the line of sight vector (S36). When there is a corresponding object (Y in S36), the hit determination unit 58 temporarily stores the object as a provisional hit object in an internal memory or the like (S38). As described above, the checks in S32 and S36 may actually be performed simultaneously.

When there is no provisional hit object (N in S32, N in S36, Y in S40), the hit determination unit 58 notifies the selection determination unit 60 that there is no hit object (S42). When there is a provisional hit object (N in S40) and there is only one (Y in S44), the hit determination unit 58 determines that object as the hit object and notifies the selection determination unit 60 of this information (S46). When there are multiple provisional hit objects (N in S44), the hit determination unit 58 first checks whether any of them meets the conditions for division (S48).

The condition for division is, qualitatively, as described above, when at least a part of the provisional hit object overlaps front and back as viewed from the viewpoint, and the apparent size of the back object is larger than the front object. In such a situation, even when wanting to select a front object, when it moves or the line of sight wavers, there is a high probability that the line of sight will hit a back object. By dividing the back object and roughly aligning the granularity of the hit object, it is possible to prevent the back object from continuing to be selected for reasons such as being hit for a long time when the selection determination unit 60 determines the selection target.

When there is an object among the provisional hit objects that satisfies the division condition (N in S48), the hit determination unit 58 divides the object according to a predetermined rule and performs hit determination again in units of that division (S50). That is, the hit determination unit 58 performs the checks in S32 and S36 on the partial objects that are formed by dividing them. As a result, of the apparently large provisional hit objects, only the portion that is in the line of sight or that is in the margin region becomes the provisional hit object. The hit determination unit 58 rewrites the information of the object before division, which is temporarily stored in the memory, with information of the corresponding part after division.

At this time, the hit determination unit 58 stores the distance value from the line of sight vector for each partial object after division in the distance data storage unit 62. When there is no object that satisfies the division condition (Y in S48), or after dividing the object that satisfies the division condition, the hit determination unit 58 checks whether there is an object that is clearly close to the gaze point among the provisional hit objects detected up to that point (S52). The hit determination unit 58 acquires, for example, from the line of sight information acquisition unit 56, the three-dimensional position coordinates of the gaze point based on the gaze point distance, and calculates the distance to the surface of the provisional hit object, or the like

The three-dimensional gaze point may be by acquired after calculation by the line of sight detector 12 or may be calculated by the hit determination unit 58 itself. In the latter case, the hit determination unit 58 acquires the line of sight vectors of the left and right eyes from the line of sight detector 12 via the line of sight information acquisition unit 56, and calculates the position coordinates where they intersect as the gaze point.

By incorporating the gaze point distance, when there are provisional hit objects at different distances from the viewpoint, it is possible to narrow down the objects to which the user likely has aligned their line of sight based on distance. For example, when the difference in distance from the gaze point to the provisional hit object is equal to or greater than a predetermined value, the hit determination unit 58 determines that there is a clear difference in distance (Y in S52). The hit determination unit 58 then determines one or more objects that belong to the closer distance group as hit objects and notifies the selection determination unit 60 of this information (S54). When there is no clear difference in the distance from the gaze point (N in S52), the hit determination unit 58 will notify the selection determination unit 60 of information on all provisional hit objects (S56).

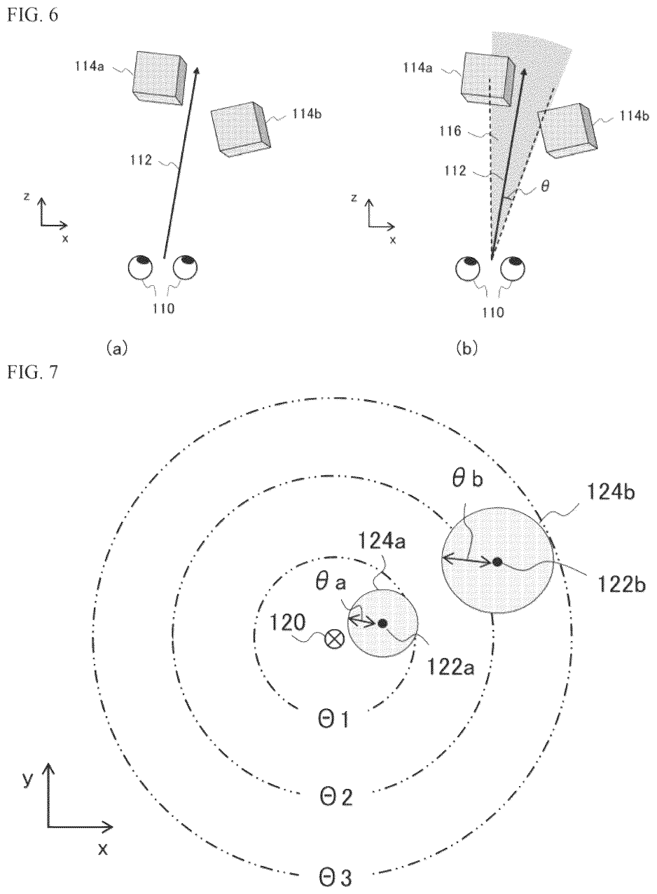

FIG. 6 schematically illustrates how the hit determination unit 58 performs hit determination in S32 and S36 of FIG. 5. The drawing illustrates a user's viewpoint 110 and a bird's-eye view of objects 114a and 114b virtually placed in front of the user's eyes, but the number of objects is not limited. The viewpoint 110 is, for example, the midpoint between the left and right eyes. In the drawing, the horizontal direction is the x axis and the depth direction is the z axis, with the viewpoint 110 as the reference point.

In the process of S32, the hit determination unit 58 determines whether the line of sight vector 112 hits the objects 114a and 114b, as illustrated in (a). When the line of sight vector 112 hits either of the objects 114a and 114b, the hit determination unit 58 determines that object as a provisional hit object. When the line of sight vector 112 hits multiple objects, the hit determination unit 58 may determine the object that is closest to the viewpoint 110 as a provisional hit object. In the illustrated example, the line of sight vector 112 does not hit either of the objects 114a and 114b.

Next, the hit determination unit 58 determines whether at least a portion of the objects 114a and 114b is within the margin region 116, which, when viewed from the viewpoint 110, forms an angle of a predetermined value 0 with the line of sight vector 112, as illustrated in gray in (b). That is, the margin region 116 is the inner region of a cone with the viewpoint 110 as the vertex, the line of sight vector 112 as the central axis, and a half apex angle θ. The hit determination unit 58 determines an object at least a part of which is within the margin region 116 as a provisional hit object.

In the illustrated example, both of the objects 114a and 114b are within the margin region 116. When a plurality of objects are in the margin region 116 in this manner, the hit determination unit 58 may designate the one closer to the line of sight vector 112 as the provisional hit object. In this case, in the illustrated example, the object 114a becomes the provisional hit object.

FIG. 7 illustrates an example of rules for determining the angle θ from the line of sight vector, which the hit determination unit 58 uses to set the margin region. This drawing illustrates the viewpoint vector as seen from the viewpoint 110 side, with the horizontal direction as seen from the viewpoint being the x axis and the vertical direction as seen from the viewpoint being the y axis. Furthermore, when the line of sight vector 120 when facing forward, that is, in the z axis direction in FIG. 6, is used as reference, then looking at a position away from that will result in an angular difference from the reference line of sight vector. In general, the detection accuracy of the line of sight detector 12 is not uniform, and in many cases has a distribution depending on the line of sight direction. Moreover, the distribution of accuracy varies depending on the line of sight detector 12.

Based on this, in the present embodiment, the distribution of the accuracy of the line of sight detector 12 is acquired in advance. Then, the hit determination unit 58 adjusts the width of the margin region used for hit determination, that is, the angle range relative to the line of sight vector, in accordance with the expected accuracy of the line of sight detection result. Qualitatively, the lower the detection accuracy of the line of sight vector, the larger the margin region is made, and thus the accuracy of the hit determination becomes roughly uniform regardless of the detection error of the line of sight vector. For example, when using a line of sight detector 12 whose accuracy decreases as the direction of the line of sight vector deviates from the front direction of the eye, as illustrated in the drawing, a margin region 124a is given to a line of sight vector 122a that is close to the front direction, and a margin region 124b is given to a line of sight vector 122b that has a larger angle.

The hit determination unit 58, for example, sets an angle range with the angles Θ1, Θ2, Θ3, . . . formed with the line of sight vector 120 in the forward direction as boundaries, and determines the width of the margin regions 124a, 124b based on the angle range to which the detected line of sight vectors 122a and 112b belong. In the illustrated example, the angle between line of sight vector 122a and line of sight vector 120 in the front direction is equal to or smaller than Θ1, so the angle of margin region 124a is set to θa. The angle between line of sight vector 122b and line of sight vector 120 in the front direction is greater than 02 and equal to or less than Θ3, the angle of margin region 124a is set to θb, which is greater than θa. When the angle with respect to line of sight vector 120 is greater than Θ1 and equal to or less than Θ2, the angle of the marginal region is set to an intermediate value between θa and θb.

However, the width of the margin region is not limited to the stepwise adjustment as illustrated in the drawing, and may be changed continuously by a function that uses the angle from the line of sight vector 120 in the front direction as a variable. The rules for changing the width of such margin regions may be optimized according to the characteristics of the line of sight detector 12 as well as the individual user and the user's attributes and the like. In any case, the distribution of line of sight detection accuracy is acquired through prior trials or logical estimation, and appropriate rules for changing the width of the margin region are set accordingly and stored in memory inside the hit determination unit 58.

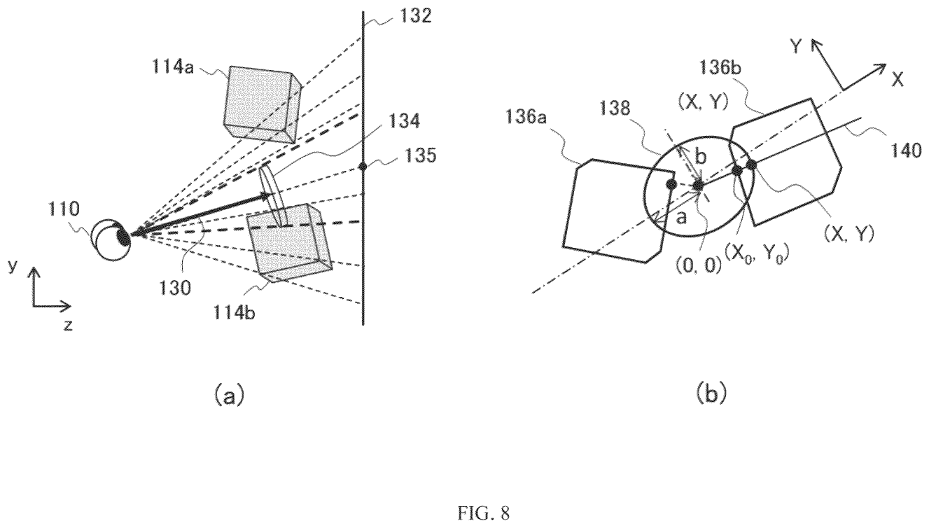

FIG. 8 is a diagram for describing an example of a technique in which the hit determination unit 58 performs hit determination using a margin region. (a) illustrates a side view of the viewpoint 110 and the line of sight vector 130, with the vertical direction relative to the viewpoint 110 as the y axis and the depth direction as the z axis. As described above, the hit determination unit 58 generates a margin region of a predetermined angle centered on the detected line of sight vector 130. In the drawing, a ring representing a portion of the cone side surface corresponding to the boundary of the margin region is illustrated as a margin region boundary 134.

In order to check whether at least a part of the objects 114a and 114b is within the margin region boundary 134, the hit determination unit 58 projects them onto a predetermined projection plane 132 and then determines whether the outline is inside or outside. This allows for determination through two-dimensional calculations, reducing the processing load. Specifically, the hit determination unit 58 sets a flat projection plane 132 behind the objects 114a and 114b as viewed from the viewpoint 110 in the three-dimensional space of the image world, and centrally projects the objects 114a and 114b from the viewpoint 110.
(b) illustrates the projection plane 132 as viewed from the viewpoint 110 side, illustrating the contours 136a and 136b of the images of the objects 114a and 114b, and the margin region boundary 138 on the projection plane 132. In essence, the margin region boundary 138 is an ellipse that depends on the angle between the line of sight vector 130 and the projection plane 132. Therefore, the hit determination unit 58 converts the contours 136a and 136b and the margin region boundary 138 into a coordinate system in which the center of the ellipse constituting the latter is the origin, the major axis is the X axis, and the minor axis is the Y axis. Here, the center of the ellipse corresponds to the point 135 where the line of sight vector 130 intersects with the projection plane 132.

When defining the major axis radius of the ellipse that forms the margin region boundary 138 as a and the minor axis radius as b, the coordinates (X, Y) on the ellipse can be expressed as follows.

$$X 2 / a 2 + Y 2 / b 2 = 1$$

The hit determination unit 58 determines the point (X0, Y0) on the contours 136 a and 136b of the object's mapping that is closest to the origin of the XY coordinate system.

A line 140 passing through the obtained point (X0, X0) and the origin can be expressed as follows, assuming that c=Y0/Y0.

$$Y = c X$$

Using this, the intersection (X, Y) of the line 140 and the margin region boundary 138 is found as follows.

$$X = \frac{ab}{\sqrt{{b}^{2} + {a}^{2} {c}^{2}}} , Y = \frac{abc}{\sqrt{{b}^{2} + {a}^{2} {c}^{2}}} \qquad [ Math . 1 ]$$

When the distance from the origin to (X0, Y0) is smaller than the distance from the origin to (X, Y), the hit determination unit 58 determines that the contour 136b is within the margin region boundary 138 and determines the original object 114b to be a provisional hit object. For example, the hit determination unit 58 performs a similar calculation on objects within a predetermined range from the line of sight vector 130, and when the contour of the mapping is within the margin region boundary 138, records such as a provisional hit object. When multiple provisional hit objects are detected by such processing, the hit determination unit 58 may determine that only the object whose contour of the mapping is the shortest distance from the center of the margin region boundary 138 is the provisional hit object.

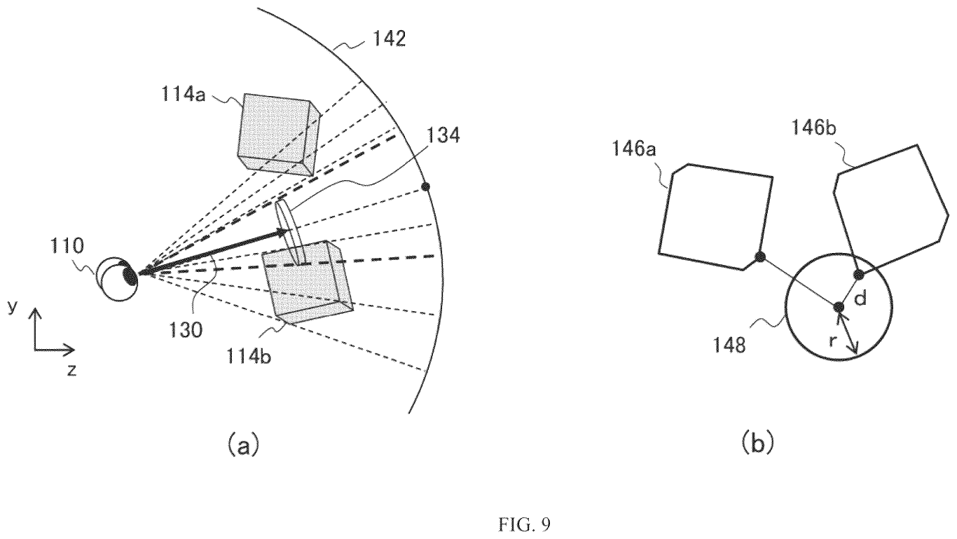

FIG. 9 is a diagram for describing another example of a technique in which the hit determination unit 58 performs hit determination using a margin region. Similarly to FIG. 8(a), (a) illustrates a side view of the viewpoint 110 and the line of sight vector 130, with the vertical direction relative to the viewpoint 110 as the y axis and the depth direction as the z axis. A part of the boundary of the margin region set for the line of sight vector 130 is illustrated as the margin region boundary 134.

Conversely, in this example, the hit determination unit 58 sets a spherical surface of a predetermined radius with the viewpoint 110 as a projection plane 142 in the three-dimensional space of the image world. The projection plane 142 is a spherical surface that encompasses the object and has a radius of, for example, 2 m or the like. The hit determination unit 58 then centrally projects the objects 114a and 114b from the viewpoint 110 onto the projection plane 142.
(b) illustrates the projection plane 142 as viewed from the viewpoint 110 side, the contours 146a and 146b of the mapping of the objects 114a and 114b, and the margin region boundary 148 at the projection plane 142. By making the projection plane 142 a spherical surface, the line of sight vector 130 intersects the projection plane 142 perpendicularly regardless of the angle. Therefore, the margin region boundary 148 is always circular, which can reduce the calculation load compared to the technique illustrated in FIG. 8.

In this case, the hit determination unit 58 finds the shortest distance (for example, distance d) from the center of the circle of the margin region boundary 148 to the contours 146a and 146b of the object's mapping. When the shortest distance is smaller than the radius r of the circle of the margin region boundary 148, it is determined that the contour 146b is within the margin region boundary 148, and the original object 114b is set as the provisional hit object. In this case as well, the hit determination unit 58 performs the same calculation on objects within a predetermined range from the line of sight vector 130 to detect provisional hit objects. Also, when multiple objects are detected, only the object that is closest to the center of the circle of the margin region boundary 148 may be determined as the provisional hit object.

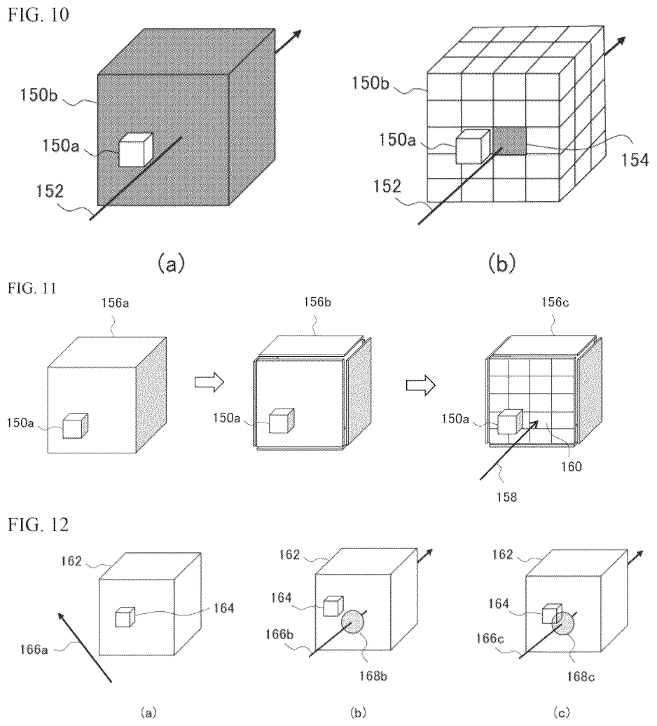

FIG. 10 is a diagram for describing how a difference in apparent size of objects affects a selection target determination process when the objects appear to overlap. First, as illustrated in (a), two objects 150a and 150b overlap each other in the front and rear in the vicinity of a line of sight vector 152, and the apparent region ratio of the back object 150b is significantly larger than that of the front object 150a.

When the user's line of sight, which is aligned on the object 150a, fluctuates or the object 150a moves, causing the line of sight vector 152 to deviate from the object 150a that the user originally wanted to select, there is a high possibility that the line of sight vector 152 will hit the back object 150b. As a result, as illustrated by the hatched region in the drawing, the entire object 150b is determined to be a hit object, and selection determination is made on that basis. Even when the hit determination is repeated, the object 150b is more frequently determined as the hit object.

As described above, the selection determination unit 60 switches the selection target based on positional and temporal predominance, and naturally, the object 150b that is hit by the line of sight vector 152 for a long period of time is more likely to be selected. Once the selection determination unit 60 has determined a selection target, some strict conditions are imposed on switching the selection target to another object in order to avoid frequent switching of the selection target. These synergistic effects can result in an undesirable situation where the object 150a that you actually want to select is not selected, and instead another object 150b is selected instead.

Therefore, in the present embodiment, as described above, the hit determination unit 58 divides the back object 150b when at least a portion of the provisional hit objects overlap and the apparent region of the back object 150b has a ratio of a predetermined value or more to the front object 150a. However, the hit determination unit 58 is not limited to strictly comparing apparent regions and may determine whether division is necessary based on an approximate size relationship estimated from the size of the object itself.
(b) in the drawing illustrates the object 150b after division. The hit determination unit 58 performs hit determination again for each partial object obtained by dividing the object 150b (hereinafter referred to as a “partial object”). In the example illustrated in the drawing, only a partial object 154 illustrated in the shaded region is set as a provisional hit object. As described above, the hit determination unit 58 recalculates the distance from the line of sight vector 152 for each divided unit and stores the calculated distance in the distance data storage unit 62.

When the partial object 154 is determined to be the final hit object, the selection determination unit 60, for example, compares the object 150a that had been selected up to that point with the partial object 154, and determines whether to switch the selection target. The apparent size of the partial object 154 is approximately the same as that of the object 150a, and thus the probability of it being struck by the line of sight and the probability of the line of sight hitting are also approximately the same.

In other words, it is possible to avoid a state in which the line of sight hits the partial object 154 for a relatively long time, and thus the selection determination can be made based on the original comparison principle. Even assuming the granularity of hit detection and selection detection is set to units of the partial object 154, when the partial object 154 satisfies the conditions for selection, the selection target itself may be the entire object 150b.

FIG. 11 illustrates an example of a technique for dividing an object by the hit determination unit 58. In the example of FIG. 10, a cube is divided at equal intervals in the three axial directions to generate cubic partial objects. In this case, partial objects are also formed behind or inside the object that is not related to the line of sight, resulting in an increase in unnecessary calculations. Therefore, the hit determination unit 58 limits the partial objects to be subjected to hit determination by dividing only the surfaces that the line of sight vector hits or the surfaces that are within a predetermined range from the line of sight vector.

In the example illustrated in the drawing, the hit determination unit 58 first virtually generates a hollow object 156b consisting of only the surface of a division target object 156a. In the case of the cube illustrated in the drawing, the hollow object 156b is composed of an object having six faces. Furthermore, the hit determination unit 58 divides only the surface of the hollow object 156b that is struck by the line of sight vector 158, or the surface that falls within a predetermined range from the line of sight vector 158, as will be described later (object 156c). In the illustrated example, the front surface which the line of sight vector 158 hits is divided into four parts both vertically and horizontally, forming 16 partial objects (for example, partial objects 160).

The hit determination unit 58 determines the number of divisions so that the ratio between the apparent area of the partial object and the apparent area of the object 150a in front is a value close to 1 within a predetermined range. Although the diagram illustrates an example of division using a cubic object as an example, the shapes of the surfaces and division target areas and the division boundary may vary depending on the shape of the object.

FIG. 12 is a diagram for describing the conditions for the hit determination unit 58 to divide an object from the relationship with the line of sight vector. (a), (b), and (c) all illustrate a state in which another object 162 is located behind an object 164, and the ratio of the apparent area of the latter to the former is equal to or greater than a predetermined value. Even when the front-to-back relationship and apparent area ratio of the objects satisfy the division conditions in this way, unless both objects 162 and 164 are provisional hit objects, the hit determination unit 58 will not divide the object 162.

As an example of no division, (a) illustrates a case where the line of sight vector 166a does not hit either object, and (b) illustrates a case where the line of sight vector 166b hits the back object 162, but the front object 164 is not included in the margin region 168b. Conversely, in the case of (c), the line of sight vector 166c hits the back object 162, and the front object 164 is included in the margin region 168c thereof, so both are extracted as provisional hit objects.

In such a case, the hit determination unit 58 determines the division of the back object 162. Other conditions for determining division include when the line of sight vector 166c hits the front object 164 and the margin region thereof includes the back object 162, when the line of sight vector 166c passes through both objects 164 and 166 and the distance from the viewpoint is not used to narrow down the search, and the like. Note that when there are multiple large objects in the background, the target to be divided may be only the object closest to the front, which is likely to be hit by the line of sight.

As described above, the conditions for division include the apparent area ratio. For example, the hit determination unit 58 divides the back object 162 when the area ratio of the back object 162 to the front object 164 is 1.2 times or more. Conversely, dividing an object has the effect of making the object less likely to become a selection target, so it is conceivable that uniform conditions may instead cause inconvenience.

For example, in an electronic game, when wanting to select and defeat a large enemy behind a small enemy moving in the foreground, when you immediately move out of the line of sight from a partial region of the large enemy object that has become a hit object, the temporal predominance will be reset. As a result, it may take some time to become the selection target, or the selection target may unintentionally switch to the front object, making it difficult to attack at the right time.

Therefore, the conditions for dividing the object may be optimized depending on the content of the information processing such as a game, the characteristics and speed of the object's movement, the shape of the object, and the like. Qualitatively, when the likelihood of a line of sight vector hitting a back object exceeds an allowable range compared to a front object, the back object is divided to mitigate the difference in likelihood of hitting.

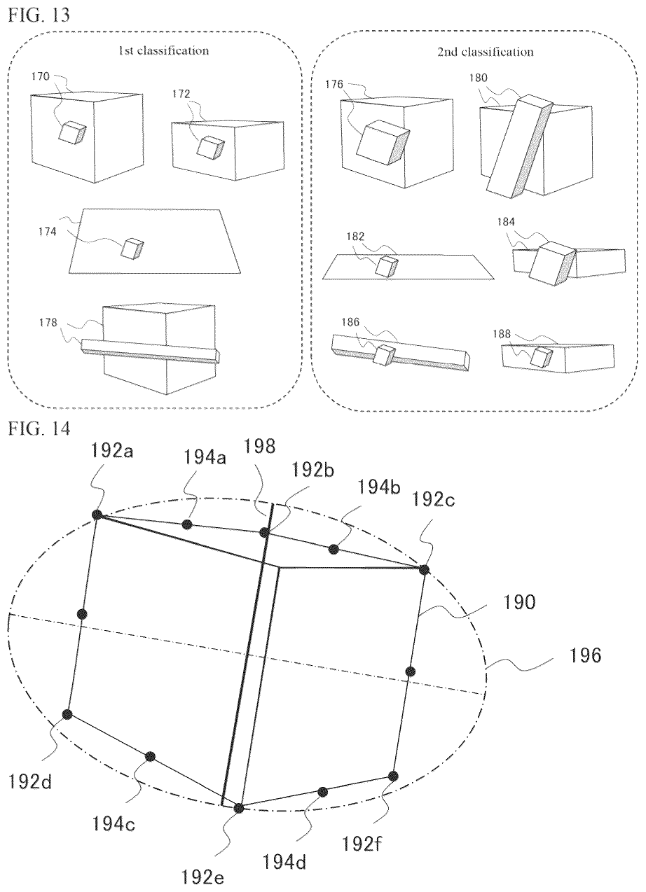

FIG. 13 illustrates an example in which combinations of objects of various shapes are classified according to division necessity. The first category is object pairs for which division is desirable, and the second category is object pairs for which division is not necessary. As illustrated in the examples above, when the apparent shapes of both the back and front objects are close to a square or a circle, the probability that the line of sight will wander is less dependent on the direction, so the division necessity can be determined simply by setting a threshold value for the area ratio.

In the illustrated example, object pairs 170, 172, 174, and 176 correspond to this. Of these, object pairs 170, 172, and 174 are classified as the first category because the area ratio of the back object is large, and an object pair 176 is classified as the second category because the area ratio is not so large.

Conversely, when an object has a significant difference in width and height even when the area ratio is similar, the probability that the line of sight will be averted depends on the direction. In other words, when the line of sight moves in a narrow direction, the line of sight is more likely to be off target, just like with smaller objects. For example, in object pair 178, the front object is long horizontally and narrow vertically, and thus when the line of sight moves vertically, it will hit the back object. In this case, even when there is no significant difference in the area ratio, there will be a difference in how easily the object will be hit by the line of sight, so it is desirable to divide the back object.

Conversely, when the front object has a certain amount of width, as in object pair 180, the difference in hit likelihood becomes small, and division becomes unnecessary. Conversely, when the width of the back object is narrow in a certain direction, the line of sight will likely hit a region where no object is present, so there is no need to divide even when the region ratio is large. Therefore, in the illustrated example, object pairs 182, 184, 186, and 188 are classified as the second category.

FIG. 14 is a diagram for describing an example of a technique for determining division necessity based on a shape of an object. In this example, the hit determination unit 58 approximates the apparent shape of the object with an ellipse, and the length of the minor axis of the ellipse is used as an index of how likely it is to be hit by the line of sight. For example, the hit determination unit 58 projects an object onto a projection plane such as that illustrated in FIGS. 8 and 9, and identifies a plurality of position coordinates on the contour 190 of the projection as reference points.

In the example illustrated in the drawing, a rectangular parallelepiped object is assumed, so the hit determination unit 58 acquires the position coordinates of vertex images 192a, 192b, 192c, 192d, 192e, and 192f as reference points. Furthermore, the hit determination unit 58 acquires position coordinates of images 194a, 194b, 194c, and 194d of the midpoints of the sides of the object as reference points. However, as long as the ellipse can be accurately approximated, there are no particular limitations on the objects and number of reference points.

Next, the hit determination unit 58 obtains an ellipse 196 that approximates the distribution of the acquired reference points using the least squares method or the like, and acquires the length of a minor axis 198 thereof as an index of the likelihood of being hit by the line of sight. By using the length of the minor axis of the approximate ellipse, it is possible to evaluate the likelihood of an object being hit by the line of sight regardless of its apparent shape. For example, in the example of FIG. 13, when the ratio of the index values of the back object compared to the front object is equal to or greater than a predetermined value, the hit determination unit 58 classifies the object pair as the first category and separates the back object.

The example in the drawing is a technique for evaluating the likelihood of being hit by the line of sight based on the shape of an object, but as described above, the likelihood of being hit by the line of sight also changes depending on whether the object is moving and the speed thereof. Therefore, the index of the likelihood of being hit by the line of sight is not limited to that illustrated in the drawing, and for example, the greater the speed, the lower the likelihood of being hit, or the index of the likelihood of being hit may be derived by combining at least two of the speed, shape, and area.

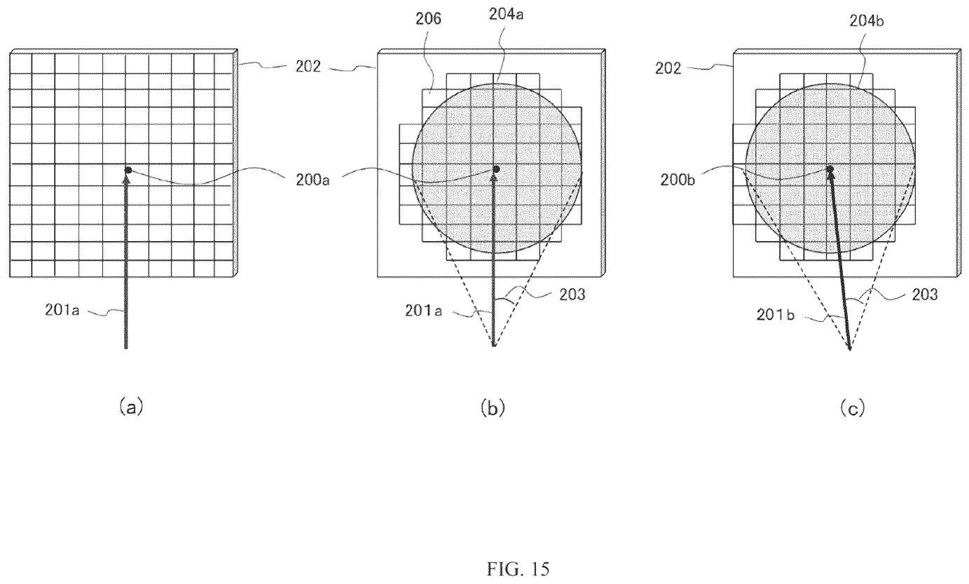

FIG. 15 is a diagram for describing an aspect in which the hit determination unit 58 limits a range for dividing the object. As illustrated in FIG. 11, the hit determination unit 58 divides at least the portion of the surface of the division target that is hit by the line of sight vector. In the illustrated embodiment, the range for dividing the surface is further limited, thereby making the hit determination process more efficient. (a), (b), and (c) in the drawing all illustrate a square surface 202, which is a division target.

In (a), when the line of sight vector 201a hits a point 200a and a surface 202 is determined to be the division target, hit determination unit 58 first divides surface 202 evenly, for example, as illustrated in the grid pattern in the drawing, to form provisional partial objects. Next, as illustrated in (b), the hit determination unit 58 determines as the final group of partial objects a group of partial objects (for example, partial objects 206) at least a part of which is included in a region 204a where the angle 203 formed with the line of sight vector 201a when viewed from the viewpoint is within a predetermined value. Here, the upper limit of the angle 203 that determines the region 204a is set to, for example, 200 or the like.

On the surface 202, the region 204a has a circular or elliptical shape centered on the point 200a which the line of sight vector 201a hits. The hit determination unit 58 performs hit determination again for the partial object group, obtains the distance from the line of sight vector, that is, the distance from the point 200a, and stores the distance in the distance data storage unit 62.

As illustrated in (c), when a point 200b where a line of sight vector 201b hits moves within the surface due to the movement of the line of sight vector or the surface 200 itself, the hit determination unit 58 moves a region 204b where the partial object is generated to match the point 200b. That is, by maintaining the upper limit of the angle 203 formed by the line of sight vector 201b when viewed from the viewpoint, the region 204b moves. As a result, the partial object group changes, so the hit determination unit 58 performs hit determination again for the new partial object group, obtains the distance from the line of sight vector, and stores the distance in the distance data storage unit 62.

By generating partial objects within a limited region of a predetermined range centered on the line of sight vector, the amount of calculation required to process partial objects can be kept constant regardless of the size of the object. Furthermore, by acquiring distance data over a range wider than the margin region used for hit detection, even when the line of sight vector moves to some extent, it is possible to accurately filter distance values using past data, thereby stabilizing selection detection.

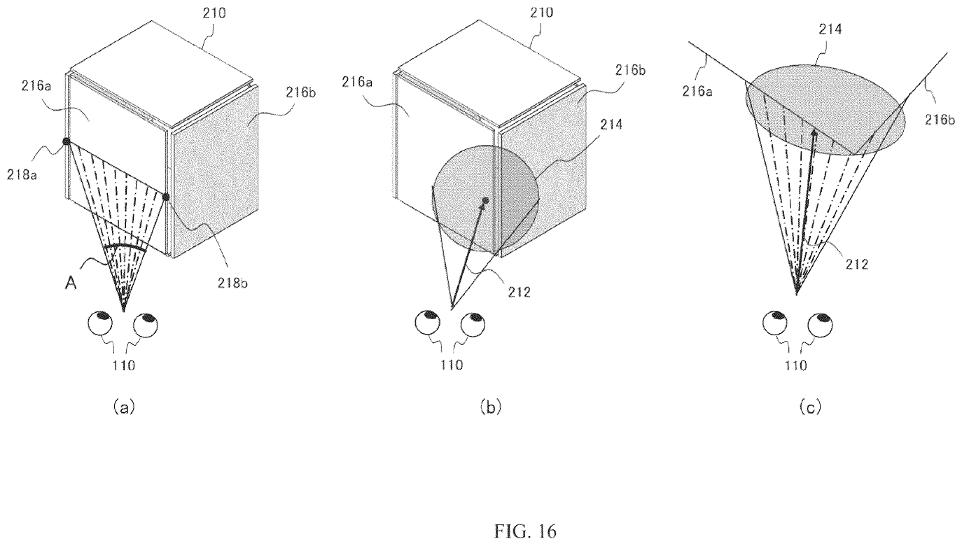

FIG. 16 is a diagram for describing an example of division rules that take into account a case where a surface of an object is tilted with respect to the viewpoint. (a) and (b) are schematic diagrams illustrating the viewpoint 110 and an object 210 as viewed obliquely from above. It should be noted that there are other objects in front of the object 210, but they are not illustrated here. As described in FIG. 15, when referring to (b), the hit determination unit 58 generates a group of partial objects that lie within a range 214 where the angle formed with the line of sight vector 212 when viewed from the viewpoint 110 is within a predetermined value. Note that in the illustrated example, two surfaces 216a and 216b are division targets.

In this way, by determining the range for generating a group of partial objects based on the angle from the viewpoint 110 rather than using length in the image world as a measure, it is possible to appropriately set the range 214 corresponding to the movement of the line of sight vector regardless of the inclination or distance of the object 210. This characteristic also applies to setting dividing boundaries of an object. In other words, as illustrated in the drawing, when we consider a situation where the object is tilted relative to the line of sight vector, simply dividing the surface equally may result in the generation of seemingly small partial objects, which may ultimately affect the accuracy of the selection determination.

Therefore, the hit determination unit 58 divides the surface of the object 210 at boundaries where the angles from the viewpoint 110 are equal intervals, as illustrated in (a). Specifically, the hit determination unit 58 first determines the position coordinates of the midpoints of opposing sides (for example, midpoints 218a and 218b) on the division target surface 216a, and then determines an angle A formed by the line segment from the viewpoint 110 to the midpoints. The number of divisions is then determined as an integer N=|A/B|, which is the solution obtained by dividing the angle A by a predetermined division angle B, such as 3°.

Then, the hit determination unit 58 divides the surface 216 into equal divisions B in the direction of the line segment connecting the midpoints 218a and 218b. This allows division at an angle width that is close to approximately the target value B of the division angle. In the drawing, the angle of the dividing boundary is indicated by a dashed line. By performing similar processing on both the vertical and horizontal sides of the surfaces 216a and 216b, a group of rectangular partial objects can be formed.

Meanwhile, the hit determination unit 58 determines a range 214 as illustrated in (b) and determines the partial objects within that range as a final partial object group. (c) illustrates a bird's-eye view of the viewpoint 110 and the surfaces 216a and 216b illustrated in (a) and (b). The hit determination unit 58 divides the surfaces 216a and 216b equally based on the angle from the viewpoint 110 and validates the partial objects that fall within the range 214, thereby generating a group of partial objects of apparently equal size in the vicinity of the line of sight vector 212.

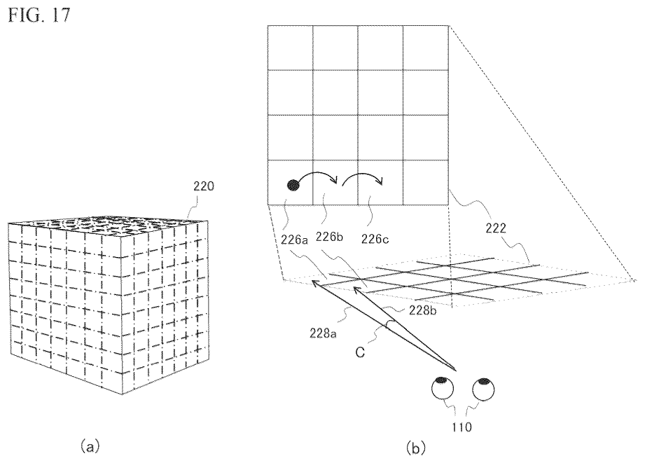

FIG. 17 is a diagram for describing another example of division rules that take into account a case where a surface of an object is tilted with respect to the viewpoint. In this example, each face of an object 220 is typically divided equally into segments with a length scale in the image world. (a) is a schematic diagram of the object 220 in this case as seen from the viewpoint, with the line of sight vector approximately perpendicular to the plane of the drawing. In this case, the closer a surface is to being parallel to the line of sight vector, such as the top surface of the object 220, the smaller the apparent size of the partial objects obtained by division, which may have a negative effect on the accuracy of selection determination. Furthermore, the larger the object 220, the greater the number of partial objects, which increases the computational load and the required memory capacity.

Therefore, when the hit determination unit 58 acquires the distance value from the line of sight vector of each partial object, when there is no difference in the angle from the viewpoint between adjacent partial objects that is equal to or greater than a predetermined value, calculation of the distance value for that partial object is skipped. (b) illustrates a surface 222, which is a part of the upper surface of the object 220, as viewed from the viewpoint and from the front. As described above, the division target may be within a predetermined angle range with respect to the line of sight vector.

For example, the hit determination unit 58 finds the distance from the line of sight vector to the lower left partial object 226a indicated by a black circle among the partial objects already formed on the surface 222. Next, the hit determination unit 58 determines the partial object 226b to the right as a distance acquisition target. At this time, the hit determination unit 58 calculates an angle C formed by the vectors 228a and 228b to the centers of the partial object 226a, for which the distance has already been acquired, and the partial object 226b adjacent to the right, on the plane 222 seen from the viewpoint 110. However, the end points of the vectors 228a and 228b are not limited to the centers as long as they are common to the partial objects.

When the angle C is less than a predetermined value, it is determined that the granularity of the partial object is too fine, and the hit determination unit 58 skips acquiring the distance value for the partial object 226b. Then, the hit determination unit 58 determines a target for acquiring the distance in the partial object 226c to the right of the target. In this case as well, the hit determination unit 58 obtains the angle formed by the vectors to the partial object 226a for which the distance has already been acquired and the target partial object 226c, and skips obtaining the distance value when the angle is less than a predetermined value.

Tn this way, the hit determination unit 58 scans the partial objects generated in advance in a predetermined order, and obtains distance values only for partial objects whose angle from the partial object whose distance was acquired last time is equal to or greater than a predetermined value. In this way, the skipped partial object and the partial object for which the distance value was previously acquired are essentially combined into one partial object. This technique also makes it possible to generate partial objects that have roughly equal areas when viewed from the viewpoint.

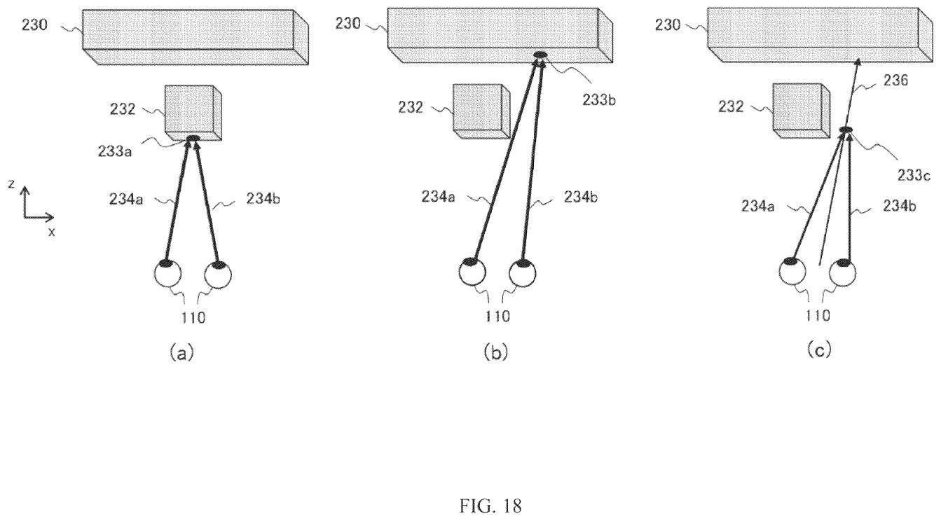

FIG. 18 schematically illustrates, in S52 of FIG. 5, the hit determination unit 58 determining the hit object using the gaze point distance. (a), (b), and (c) all illustrate a bird's-eye view of a state in which provisional hit objects 230 and 232 are positioned in front of and behind the viewpoint 110. When the gaze point distance is used as described above, the line of sight detector 12 acquires the line of sight vectors 234a and 234b of the left and right eyes corresponding to the viewpoint 110, and acquires the point where they intersect as the gaze point. This allows the three-dimensional gaze point, including the distance from the viewpoint 110, to be determined.

In the case of (a), a gaze point 233a is located near the front of the nearer object 232 out of the provisional hit objects 230 and 232. Therefore, the hit determination unit 58 determines the object 232 as the final hit object. In the case of (b), a gaze point 233b is located near the front of the back object 230. Therefore, the hit determination unit 58 determines the object 230 as the final hit object. However, when the provisional hit objects 230 and 232 are close to each other and there is no clear difference in distance from the gaze point that is equal to or greater than a threshold value, the hit determination unit 58 may determine both of them as hit objects.

In the case of (c), the line of sight vector 236 not taking the gaze point distance into consideration hits the back object 230, but a gaze point 230c taking the gaze point distance into consideration is near the front of the front object 232. In this case, the hit determination unit 58 may prioritize the gaze point 230c and determine the front object 232 as the final hit object, or may determine both the objects 230 and 232 as the final hit objects. By taking the gaze point distance into consideration in this way, even when the line of sight vector 236 deviates from the original object 232 due to a deviation, or the like, the probability of excluding the object 232 from the hit object can be reduced.

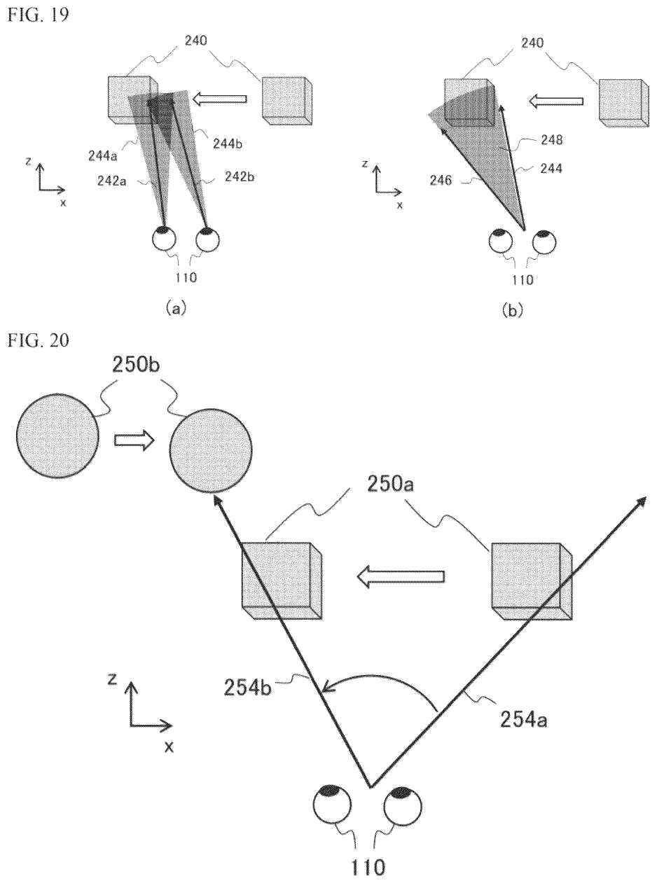

FIG. 19 illustrates variation of the margin region set by the hit determination unit 58. (a) illustrates an example in which the margin region is set using the line of sight vectors of the left and right eyes acquired when deriving the gaze point distance. In this case, the hit determination unit 58 sets the ranges within a predetermined angle from each eye as margin regions (for example, margin regions 244a and 244b) centered on the line of sight vectors 242a and 242b of the left and right eyes, respectively.

In this way, the margin region can be made wider and more directional than when a common line of sight vector is used for both the left and right eyes. This allows the object 240 to be selected to move as indicated by the arrow, and even when it is difficult to align the line of sight, the object is more likely to be within the margin region based on one of the eyes, making selection easier.
(b) illustrates an example in which a common line of sight vector is used for both the left and right eyes, but the movement of the line of sight vector is predicted and used to set the margin region. For example, the hit determination unit 58 predicts a line of sight vector 246 a predetermined time later, such as the time of the next hit determination process, based on the line of sight vector 244 at the time of hit determination. The line of sight vector after a predetermined time can be predicted using the rate of change (angular velocity) of the line of sight vector up to that point.

For example, the hit determination unit 58 acquires an average angular velocity vθ for the past 0.1 seconds. Here, vθ includes components of pitch angle and yaw angle. Then, the line of sight vector 244 at the current time is rotated by the angle of change (vθ·t) at a predetermined time t, and a line of sight vector 246 is predicted. The hit determination unit 58 sets a margin region 248 using a current line of sight vector 244 and the predicted line of sight vector 246. For example, the hit determination unit 58 determines the region inside a cone that includes the line of sight vectors 244 and 246 on its sides as the margin region 248. Alternatively, the hit determination unit 58 may determine the margin region 248 to be the inner region of a cone that encompasses a range of a predetermined angle centered on the line of sight vectors 244 and 246, respectively.

When the object 240 to be selected moves as illustrated by the arrow, the line of sight vector 244 changes to follow it. Therefore, the future line of sight vector 246 is used to expand the margin region in the direction of movement of the line of sight vector 244, and the margin region increases depending on the velocity of the object 240. This increases the likelihood that the object 240 is within the margin region 248 even when the line of sight cannot follow, making selection easier.

The predicted value of the line of sight vector may be used not only for setting the margin region but also for determining whether the line of sight vector hits an object in S32 of FIG. 5. For example, when the current line of sight vector 244 is defined as Gt and the predicted line of sight vector 246 is defined as Gt+Δt, the hit determination unit 58 acquires a line of sight vector Gt′ by weighting and averaging them as follows.

$${Gt}^{′} = α \cdot Gt + β \cdot Gt + Δ t$$

Here, α and β are weighting coefficients given to the respective line of sight vectors. However, α=β=1/2 may also be satisfied.

The line of sight vector Gt′ is the line of sight vector advanced a small time ahead. By using this to make a hit determination, it is possible to consider that a hit has occurred in accordance with the user's intention, just as in the case where a predicted line of sight vector is used to set the margin region, even when the actual line of sight does not keep up with the movement of object 240. In this case, the margin region may be within a range of a predetermined angle centered on the line of sight vector Gt′.

Note that any one of the variations of the line of sight vector and margin region described above may be adopted, or two or more may be adopted by switching between them depending on the situation. For example, when the speed of the object is below a threshold value at which the object is considered stationary, the hit determination unit uses the detected line of sight vector as is to make a hit determination, or it uses a range of a specified angle centered on that vector as a margin region. When the object's velocity exceeds a threshold, the predicted line of sight vector may be incorporated into the hit detection and margin region settings, or the margin region may be expanded using the line of sight vectors of the left and right eyes.

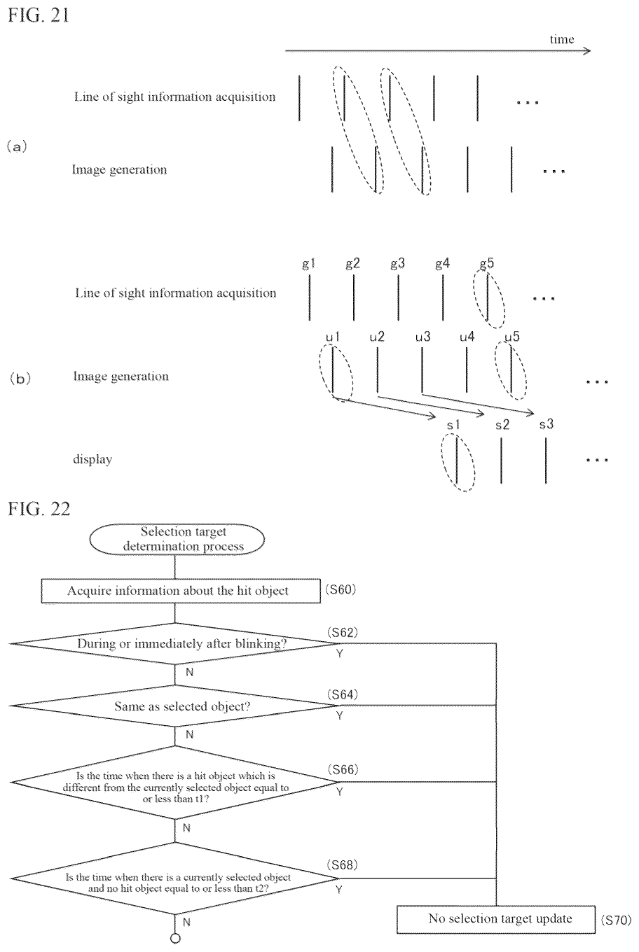

In the description so far, the hit determination unit 58 detects a hit object by evaluating the line of sight vector or the positional relationship between the margin region and the object for each frame, and uses the results of the evaluation for detection. Conversely, the hit determination unit 58 may use, as another basis, for example, a level of correlation between the movement of the object and the line of sight vector. FIG. 20 is a diagram for describing a technique for detecting a hit object based on a correlation between a line of sight vector and movement of the object. Assume that, in a predetermined short period of time, one object 250a moves from right to left relative to the viewpoint 110, and another object 250b moves from left to right. Also, during the same time, the line of sight vector moves from diagonally right (line of sight vector 254a) to diagonally left (line of sight vector 254b).

In this example, at the end of the short period of time, the line of sight vector 254b passes through both of the objects 250a and 250b, and therefore both are detected as provisional hit objects by hit determination based on the line of sight vector. Conversely, based on the correlation with the movement of the line of sight vector, it is more likely that the user intentionally aligned their line of sight on the object 250a, which was moving in the same direction. Therefore, the hit determination unit 58 may calculate a correlation coefficient between the movements of the objects 250a and 250b and the line of sight vector 254b, and determine an object having a high correlation coefficient as a hit object.

The correlation coefficient of the movement can be acquired by a general correlation analysis. The hit determination unit 58 may assign a score S to each object as follows, for example, and narrow down the hit objects based on the magnitude thereof.

$$S = α \cdot H + β \cdot D + γ \cdot R$$

Here, H is a score depending on whether the line of sight hits the target, and is set to 1 when the line of sight hits the target and 0 or the like when the line of sight does not hit. Also, D is a score based on the distance from the line of sight vector or the gaze point, and is a function that takes a larger value as the distance decreases. R is a score based on the correlation coefficient of the movements illustrated in FIG. 20, and is a function that takes a larger value as the correlation coefficient increases. α, β, and γ are weighting coefficients given to the respective scores and are set in advance.

The hit determination unit 58 may calculate the score S for each object, and determine the object with a maximum score, an object with a score within a predetermined range from the maximum score, or the like as the final hit object. The above technique of calculating the score S is just one example, and the accuracy of hit determination can be improved by calculating the score from more perspectives.

FIG. 21 is a diagram for describing a time relationship between a detected line of sight vector and an image world. In the drawing, the horizontal axis is the time axis, and the timing when the line of sight information acquisition unit 56 acquires line of sight vector information, the timing when the display image generation unit 54 generates the display image, and the timing when the display device 16 outputs the display image are illustrated by lines representing the start time of processing for one frame.
(a) illustrates, for comparison, a general case in which object selection is performed by line of sight. In a typical device, when information about a line of sight vector is acquired, hit determination is performed based on the relationship between the line of sight vector and an image of an object generated in an immediately following frame. In the drawing, a temporal combination thereof is surrounded by a dashed line. Normally, an image of an object is displayed, the user looks at it and aligns their line of sight on it, and the detection result is acquired, so the object the user is actually aligning their line of sight on is in the state from before the line of sight vector information was acquired.

According to the typical technique illustrated in (a), there is a risk that an object that is actually in the line of sight may move out of the line of sight at the time of hit detection, and may not be detected as a hit object. This tendency becomes stronger especially when the object is moving at a high speed. Therefore, in the present embodiment, the time difference between when the line of sight is aligned and when the hit determination is performed is taken into consideration, and the hit determination is performed on the previously displayed image (image world).

Specifically, referring to (b), the line of sight information acquisition unit 56 of the information processing device 10 acquires information on line of sight vectors at timings g1, g2, g3, . . . . The display image generation unit 54 uses the result of the selection determination based on the line of sight vector to start generating an image for one frame at the timing of times u1, u2, u3, . . . . As indicated by the arrows, the display device 16 starts displaying frames that were generated at times u1, u2, and u3 at times s1, s2, and s3, respectively.

As described above, the hit determination unit 58 performs hit determination by going back in time to the image world that was displayed when the line of sight vector occurred, which is a time before the time when the line of sight vector information was acquired. For example, as illustrated by the dashed line, using information on the line of sight vector acquired at time g5, a hit determination is made on the image world corresponding to the frame whose display began at the previous time s1, that is, the image world at time u1. The result is reflected in the image generated at time u5, which is after time g5.

The time to go back for hit detection depends on the time from when the line of sight actually occurs until it is detected and used for hit detection and on the time from when image generation begins until it is displayed. Therefore, the optimum value of the time is acquired in advance theoretically or through experiments and the like. The display image generation unit 54 or the selection target determination unit 50 stores information about objects in the image world used to generate the display image for the relevant time period, and performs hit determination by applying the most recently acquired line of sight vector to the past image world. This improves the accuracy of hit detection, making it easier for the user to accurately identify the intended selection target.

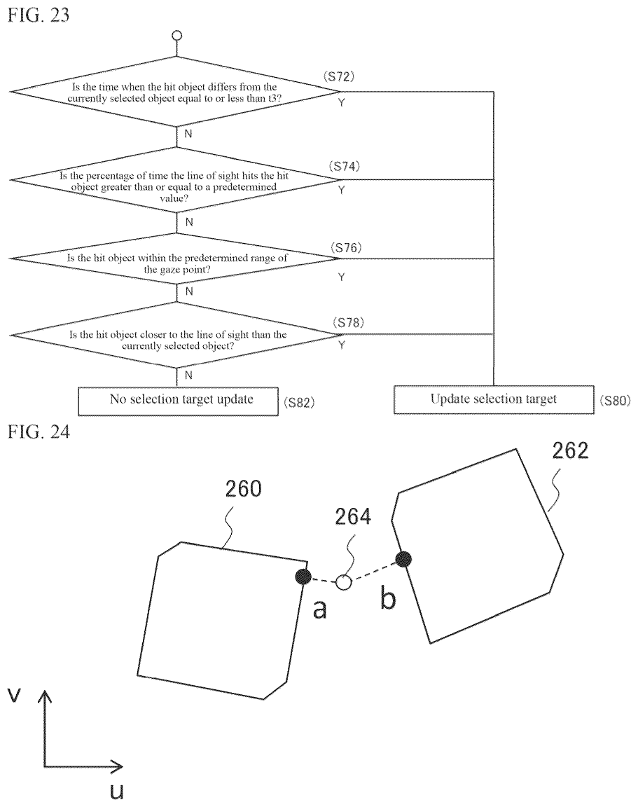

FIG. 22 and FIG. 23 are flowcharts illustrating a processing procedure in which the selection determination unit 60 determines a selection target in S18 of FIG. 4. This flowchart mainly illustrates the procedure of the determination process performed by the selection determination unit 60 when a new hit determination result is provided by the hit determination unit 58 when a currently selected object is already present.

In FIG. 22, the selection determination unit 60 first acquires information relating to the hit object from the hit determination unit 58 (S60). This information includes whether a hit object is present, and when a hit object is detected, identification information thereof. Next, the selection determination unit 60 checks whether the user is blinking or has just blinked (S62). In practice, the selection determination unit 60 constantly monitors, in cooperation with the line of sight information acquisition unit 56, whether line of sight vector information has been provided by the line of sight detector 12, thereby identifying the timing of the start and end of a blink. That is, the selection determination unit 60 determines a period in which no line of sight vector is detected as a blink period.

During the blinking period, the line of sight itself is indeterminate, and thus the selection target is not updated regardless of whether there is a currently selected object (Y in S62, S70). Even immediately after a blink, the brain's cognitive characteristics make it impossible to recognize the image, and the line of sight detection results are unstable, so the selection target is not updated regardless of whether there is a currently selected object (Y in S62, S70). The time that can be considered to be immediately after a blink is determined by a prior experiment or the like as the time from the end of a blink until the line of sight becomes stable. The time is, for example, 50 msec or the like.

When the user is not blinking or has not just blinked (N in S62), the selection determination unit 60 checks whether the hit object whose identification information was acquired in S60 is the same as the currently selected object (864). When they are the same (Y in S64), the selection determination unit 60 does not update the selection target (S70). This determination may be made in the same when even when there is no currently selected object and no new hit object. In S60, the identification information of the hit object is acquired, and when it is different from the currently selected object (N in S64), the selection determination unit 60 checks whether the persistence time of the different state is equal to or less than a predetermined value t1 (S66).

When the persistence time of the different state is equal to or less than the predetermined value t1 (Y in S66), the selection determination unit 60 does not update the selection target (S70). This determination may be made in the same way even when there is no currently selected object. Even when a new hit object is detected, when the persistence time of the line of sight state is short, it is unlikely to be the one intended by the user. The confirmation in S66 prevents the selection target from being frequently switched due to such provisional changes in the line of sight. The threshold value, persistence time t1, is the time during which the user's line of sight moves unconsciously, and is set to a value such as 50 msec through prior experiments.

When the condition of S66 is not met (N in S66), the selection determination unit 60 next checks whether the persistence time of the state in which there is a currently selected object and no new hit object is equal to or less than a predetermined value t2 (S68). When the persistence time of the state in which there is no hit object is equal to or less than the predetermined value t2 (Y in S68), the selection determination unit 60 does not update the selection target (S70). Even when the line of sight vector does not hit an object, when the persistence time of this state is very short, it is highly likely that this was not what the user intended. The confirmation in S68 prevents a selected object from being unintentionally deselected due to such a provisional change in the line of sight.

Here, the persistence time t2 that serves as the threshold value is set to a value such as 200 msec through a prior experiment. Preferably, the time limit t2 for invalidating line of sight contact with another object in S66 is set longer than the time limit t1 for invalidating the line of sight hitting another object. This allows for a certain period of time when the line of sight is accidentally shifted, while preventing unnecessary delays when the user intentionally switches selection to the next object. Note that in the confirmation of S68, when the time during which there is no hit object exceeds a predetermined value, the selection determination unit 60 may remove the currently selected object from the selection, and enter a state in which there is no selection target.

Next, referring to FIG. 23, when the above conditions are not met (N in S68), the selection determination unit 60 checks whether the persistence time of the state in which the hit object whose identification information was acquired in S60 is different from the currently selected object is equal to or greater than a predetermined value t3 (S72). Here, the threshold value t3 of the persistence time is greater than the threshold value t1 of the persistence time used in the determination of S66. When the persistence time of the different state is equal to or longer than the predetermined value t3 (Y in S72), the selection determination unit 60 updates the selection target and sets the object as the new selection target (S80). This determination may be made in the same way even when there is no currently selected object.

A state in which the line of sight hits one object for a relatively long time suggests that the user is intentionally aligning their line of sight. Therefore, by checking in S72, the object can be selected as a selection target without comparing the distance between the objects. The persistence time t3, which is the threshold value here, is set to a value such as 1,000 msec by prior experimentation or the like.

When the persistence time during which the hit object is different from the currently selected object has not reached the predetermined value t3 (N in S72), the selection determination unit 60 checks whether the proportion of time during which the hit object is hit by the line of sight vector during the most recent predetermined period is equal to or greater than a predetermined value (S74). Here, the state of “is hit by the line of sight vector” includes the case where the object is in the margin region of the line of sight vector, and can be rephrased as “is a hit object.”

Even when the persistence time of the line of sight vector hitting the object does not reach the predetermined value t3, that is, even when the line of sight moves away midway, as long as that state is maintained for a certain percentage of time or more, there is a high possibility that the user is intentionally aligning their line of sight. Therefore, when the proportion of time that the line of sight vector hits the object is equal to or greater than a predetermined value (Y in S74), the selection determination unit 60 updates the selection target and sets the object as the new selection target (S80). The period used for the determination and the time ratio therein are set by a prior experiment, for example, to a value such as 1 second (67%) of the most recent 1.5 seconds.

When the condition of S74 is not met (N in S74), the selection determination unit 60 checks whether the new hit object is within a predetermined range from the gaze point (S76). Here, the gaze point is, for example, a position coordinate in the three-dimensional space of the image world, taking into consideration the gaze point distance. For this reason, the selection determination unit 60 acquires information about the gaze point from the line of sight detector 12 via the line of sight information acquisition unit 56. Alternatively, the selection determination unit 60 may acquire information about the gaze point from the hit determination unit 58. When the new hit object is within a predetermined range from the gaze point (Y in S76), the selection determination unit 60 updates the selection target and sets the object as the new selection target (S80).

Due to the confirmation in S76, an object that is likely to be intended to be selected by the user can be made the selection target with little delay, at a timing before the relatively time-consuming determinations such as S72 and S74. Here, the distance (range) from the gaze point that is immediately determined as a selection target is set to a minimum value of 0, and is set in advance according to the scale of the image world, and the like.

When the new hit object is not within a predetermined range from the gaze point (N at S76), the selection determination unit 60 checks whether the hit object is closer to the line of sight vector than the currently selected object (S78). At this time, the selection determination unit 60 reads out from the distance data storage unit 62 the distance between the currently selected object and the line of sight vector, and the distance between the new hit object and the line of sight vector. The selection determination unit 60 filters then compares the current distance value based on a trend of past distance values and compares them. This prevents the selection target from being frequently replaced due to frequent changes in the magnitude relationship of the distances caused by temporary fluctuations, noise, or the like.

When the new hit object is closer to the line of sight vector (Y at S78), the selection determination unit 60 updates the selection target and sets the hit object as a new selection target (S80). When the currently selected object is closer to the line of sight vector (N at S78), the selection determination unit 60 does not update the selection target, and leaves the selection target as the currently selected object (S82). Note that when there is no currently selected object, the process of S78 is skipped. In this case, other conditions for the determination process may be adjusted, such as widening the range from the gaze point, which is a condition for setting a hit object as a selection target in S76.

FIG. 24 schematically illustrates a state of the selection determination unit 60 comparing the distance between the line of sight vector and the object in S78 of FIG. 23. The selection determination unit 60 reads out from the distance data storage unit 62, from among the distance values between the line of sight vector and the object derived during hit determination of the hit determination unit 58, the distance value stored in correspondence with the comparison target object, and uses this for comparison. That is, the distance value used as the basis for comparison corresponds to the distance between the image formed by projecting the object onto the projection plane illustrated in FIG. 8 or FIG. 9 and the destination of the line of sight vector.

The figure schematically illustrates an example of a positional relationship between a mapping 260 of the new hit object, a mapping 262 of the currently selected object, and a point 264 of the destination of the line of sight vector in the uv coordinate system that constitutes the projection plane. When the distance from point 264 to the mapping 260 of the hit object is a and the distance to the mapping 262 of the currently selected object is b, the selection determination unit 60 basically switches the selection target to a new hit object when a<b. However, as mentioned above, it is conceivable that when the distance at one time is used as the only basis, the selection target may be frequently switched due to the effects of noise in line of sight detection, line of sight shaking, and the like.

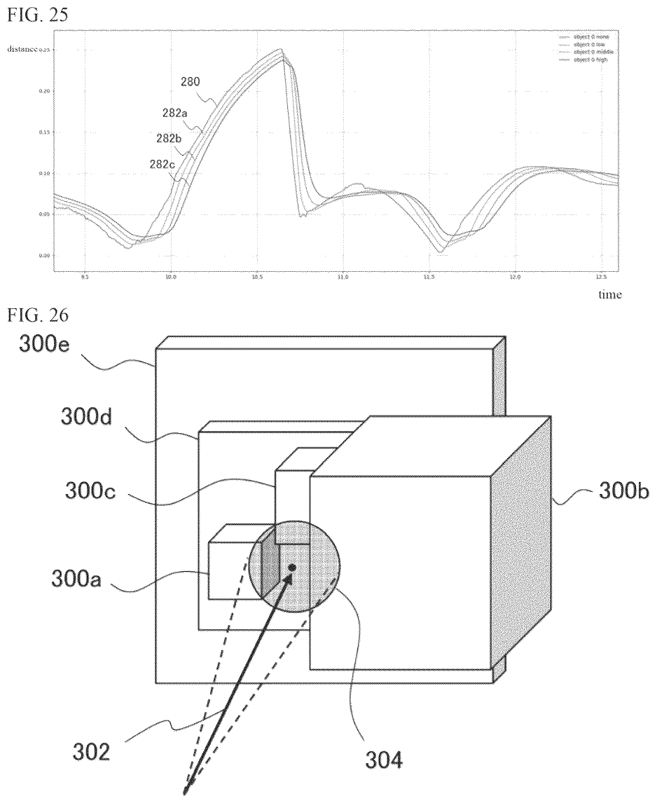

Therefore, the selection determination unit 60 applies a smoothing filter to the distance data to reduce the occurrence of such problems. FIG. 25 illustrates an example of how distance data changes due to a smoothing filter. The figure illustrates the time axis on the horizontal direction, and compares the change in distance from the line of sight vector to the object at various filter strengths. Here, a one Euro filter is used as a well-known smoothing filter, but the smoothing filter to be used is not particularly limited. In the figure, by changing the filter strength in three stages, weak, medium, and strong, for an original distance change 280, results such as distance changes 282a, 282b, and 282c are obtained.

That is, the higher the filter strength, the smoother the fluctuations in distance become, so that it is possible to avoid noise in line of sight detection and line of sight shaking immediately affecting switching of the selection target. In other words, since there is a slight delay in the change in distance, when the line of sight returns to the original position during that time, it is possible to naturally prevent the selection from being switched to a wrong object. That is, this filtering is highly compatible with the principle of the present embodiment, which estimates a likelihood that the selection target is the one intended by the user based on the length of time that the line of sight is aligned, and determines whether to switch the selection target.

On the other hand, the delay in the change in distance due to smoothing becomes an obstacle in situations where it is desired to switch the selection target immediately. Therefore, a smoothing filter having a plurality of levels of strength may be prepared in advance so that the selection determination unit 60 may filter at an appropriate strength depending on the type of information processing performed by the information processing unit 52 and, ultimately, the switching speed required for selecting objects. In this case, the smoothing filter strength may be specified in the program that defines the information processing.

As an example, it is conceivable to prepare three stages of filters, weak, medium, and strong, which generate delays of 100 msec, 300 msec, and 500 msec. However, the number of filter strength stages and delay time are not particularly limited. Note that the selection determination unit 60 may adjust the conditions for each determination in the determination process of the selection target illustrated in FIGS. 22 and 23 depending on the strength of the filtering to be adopted. For example, the greater the filter strength, the shorter the various times used for determination, so that the time until switching is not extended more than necessary.

The selection determination unit 60 basically reads out data of the relevant object from a trend of the distance values stored in the distance data storage unit 62 and performs filtering. However, while the user is blinking, the line of sight is unstable, and therefore cannot be used for filtering. Here, when the blink is long, it is conceivable that the line of sight vector immediately after the blink will change discontinuously from the line of sight vector before the blink.

For these reasons, the selection determination unit 60 preferably sets a threshold value of 500 msec or the like, and when the blink is longer than that, resets the value of the distance before the blink so that it is not used for filtering after the blink. This makes it possible to avoid the line of sight vector after the blink being influenced by the line of sight vector before the blink, resulting in an unintended selection.

As described above, the hit determination unit 58 also finds the distance from the line of sight vector for each partial object obtained by dividing an object having a large apparent size, and stores the distance in the distance data storage unit 62. When any of these becomes a hit object, the selection determination unit 60 applies a smoothing filter to the distance value of the partial object, in the same way as for a normal object. On the other hand, when the apparent size of a partial object changes due to a change in the object's posture or the like, the hit determination unit 58 may change the division boundary so as to maintain the apparent size to some extent.

When the division boundary of the partial object that is the hit object changes as a result of this, the selection determination unit 60 may use, for filtering, the distance value of the nearest partial object among the partial objects before the division boundary was changed. When the partial object that is the hit object is one that was newly generated, the selection determination unit 60 may perform the selection determination using the distance value that is obtained at the current point in time without filtering.

### (Variation of Division Necessity Determination Process)

In the aspects described above, when the ratio of the apparent size of a background object relative to an object in the foreground on the line of sight vector is equal to or greater than a predetermined value, the background object is divided, thereby equalizing the likelihood of the line of sight vector hitting, and therefore the likelihood of being selected. In present variation, the division necessity is determined taking into account a more complicated case. FIG. 26 is a diagram for describing a division condition required when the positional relationship and size of the objects diversify.

In the figure, five objects 300a, 300b, 300c, 300d, and 300e are either hitting the line of sight vector 302 or are within a margin region 304 thereof. Therefore, the hit determination unit 58 sets the objects 300a, 300b, 300c, 300d, and 300e as provisional hit objects. Furthermore, when the above-described aspect is applied, the apparent size of the object 300b most in the foreground is used as a reference to determine division necessity of the other objects.

However, in the diagram, the object 300b is relatively large, and thus when this is used as the reference, the possibility of division arises only for the object 300e, the largest. Naturally, the object 300b itself is also does not become a division target. This prevents the object division function from working properly, and as a result, the objects 300b, 300d, and the like are more likely to be selected than the object 300a, the smallest. To equalize the likelihood of the line of sight hitting and of being selected, it is necessary to determine the necessity of division of the other objects after taking the size of the object 300a, the smallest, as the reference,

Here, when an oriented bounding box (OBB; oriented bounding box) is used as an index of the “size of an object,” the size of even an object having a complex shape may be easily evaluated, and processing efficiency may be improved. An OBB is the smallest rectangular parallelepiped that encompasses part or all of an object, and is widely used for collision detection and the like between objects in representations of virtual worlds using 3D computer graphics. When an OBB that encompasses an entire object is set, the size of the OBB as-is serves as an index of the size of the object.

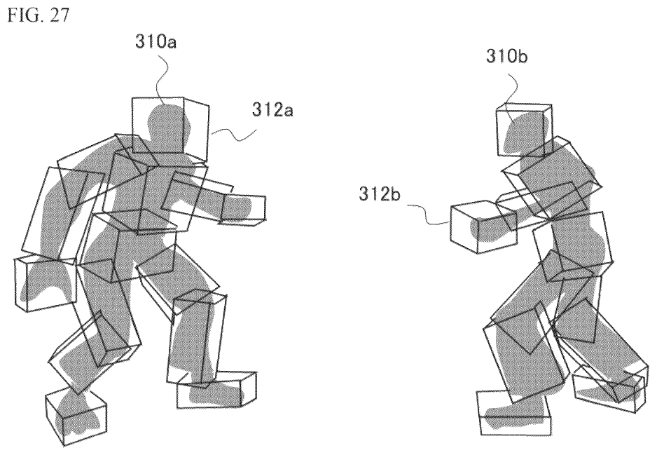

However, the OBB is defined by the program that specifies information processing, and the granularity thereof varies depending on the program. FIG. 27 schematically illustrates an example of an object in which a plurality of OBBs are set for one object. In this example, in a situation where objects 310a, 310b representing two people are fighting, OBBs (for example, OBBs 312a, 312b) are set for each part of the body.

In this case, to estimate the size of the object, it is necessary to view the object as a union of all of the OBBs that configure it. When the size of OBBs is simply compared without taking the granularity of the OBBs into consideration, and a reference OBB is set and the necessity of division determined, there may be a case where even a large object is not divided. That is, the accuracy of the object division process depends on the definition of the OBB. Furthermore, there is a possibility that unnecessary processing will increase, such as comparing a plurality of OBBs that configure the same object.

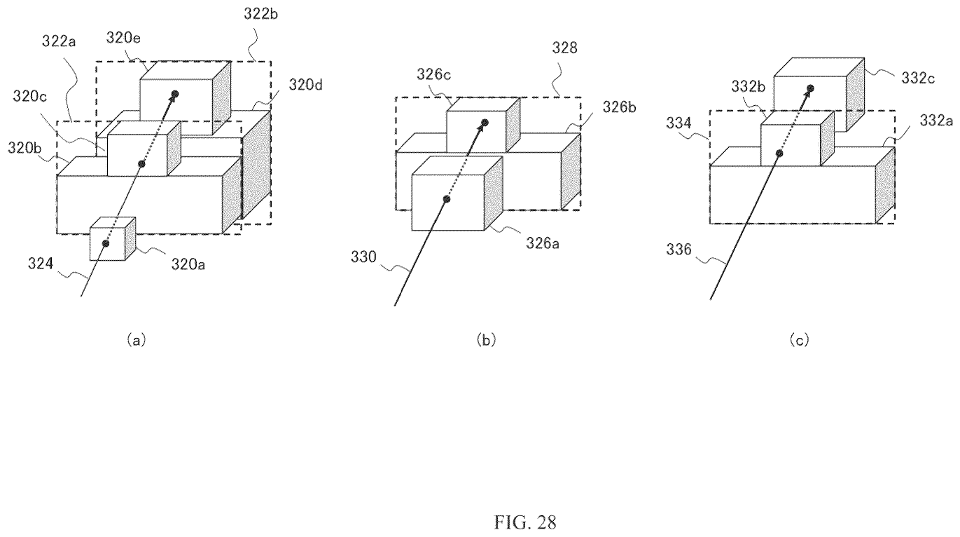

FIG. 28 is a diagram for describing a basic procedure for the hit determination unit 58 to determine the necessity of division when a case where a plurality of OBBs are defined for one object is allowed. The hit determination unit 58 basically sets as a standard the OBBs that are hit by the line of sight vector or are in the margin region in ascending order, and searches for and detects objects that satisfy the division conditions in comparison with the standard, starting from those closest to the viewpoint.

In the case of (a), OBBs 320a, 320b, 320c, 320d, and 320e overlap, and among them, OBB 320a alone configure a first object, OBB 320b and OBB 320c configure a second object, and OBB 320d and OBB 320e configure a third object.

A line of sight vector 324 passes through the OBBs 320a, 320c, 320e, and therefore the hit determination unit 58 extracts objects including these as provisional hit objects, then sets OBB 320a, the smallest, as the reference OBB. The hit determination unit 58 then determines whether the other objects should be divided based on the ratio of the size to the reference OBB, and the calculation of the ratio at this time takes into account the size of the entire object.

In the example of the diagram, the hit determination unit 58 evaluates the size of the object made up of OBBs 320b, 320c by generating, for example, a region 322a circumscribing the object. Similarly, the size of the object made up of OBBs 320d, 320e is evaluated by generating a region 322b circumscribing the object. When the size of the generated regions 322a, 322b has a ratio equal to or greater than a predetermined value relative to the reference OBB 320a, the hit determination unit 58 sets the object corresponding to the region as a division target.

In the case of (b), OBBs 326a, 326b, 326c overlap. OBB 326a alone configures a first object, and OBB 326b and OBB 326c configure a second object. A line of sight vector 330 passes through the OBBs 326a, 326c, and therefore the hit determination unit 58 extracts objects including these as provisional hit objects. In this case, the smallest OBB is the OBB 326c that corresponds to a part of the object, and therefore the hit determination unit 58 sets the OBB 326c as the reference OBB.

However, in this case, a large object of which the OBB 326c is a part is not divided, and an object made up of only the OBB 326a becomes difficult to select. Therefore, the hit determination unit 58 sets the OBB 326c, the smallest, as a first reference OBB, then additionally sets the OBB 326a, the second smallest, as a second reference OBB. The hit determination unit 58 then compares the size of the second reference OBB 326a with that of the other objects, and when the ratio of the latter is equal to or greater than a predetermined value, the object is set as a division target.

Here, the size of the object may be evaluated by generating a region 328 circumscribing the OBBs 326b, 326c, as in (a). In this way, by setting a plurality of reference OBBs, it is possible to compare the sizes of the OBBs and objects with each other, and to extract all objects to be divided. In the case of (c), OBBs 332a, 332b, 332c overlap, and among them, the OBB 332a and the OBB 332b configure a first object, and the OBB 332c alone configures a second object.

A line of sight vector 336 passes through the OBBs 332b, 332c, and therefore the hit determination unit 58 extracts objects including these as provisional hit objects. When the same rule as in (b) is applied, the hit determination unit 58 sets the OBB 332b, the smallest, as a first reference and the OBB 332c, the second smallest, as a second reference.

In this case as well, the size of the object including the OBBs 332a, 332b is evaluated by a circumscribing region 334. When the size of the region 334 has a ratio equal to or greater than a predetermined value relative to the second reference OBB 332c, the hit determination unit 58 sets the corresponding object as a division target. Note that in the case of (c), a large object is in the foreground, and division is therefore not essential, but division is acceptable, so priority is given to applying common rules to all cases and simplifying the processing.

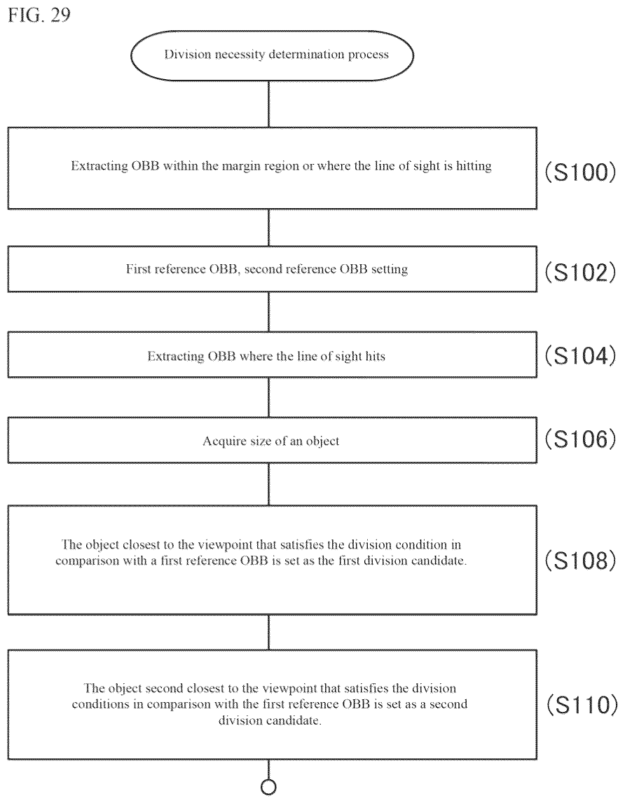

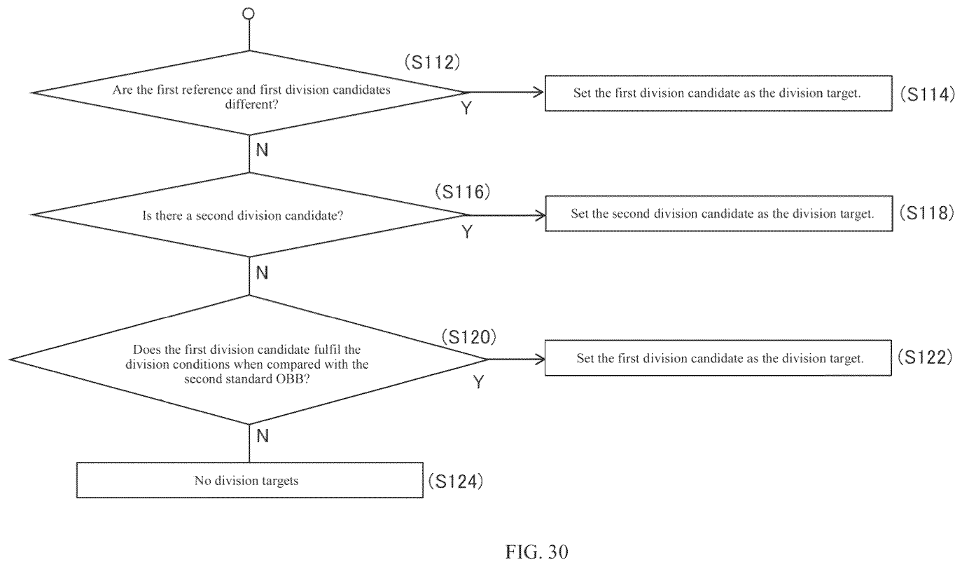

FIGS. 29 and 30 are flowcharts illustrating a processing procedure in which the hit determination unit 58 determines division necessity of an object in the present variation. This flowchart is implemented in the division necessity checking processing of a provisional hit object in S48 in the flowchart shown in FIG. 5. Referring to FIG. 29, first, the hit determination unit 58 extracts an OBB that is hit by the line of sight or is in the margin region among OBBs that configure the provisional hit object (S100). The hit determination unit 58 sets, among these, the smallest OBB as a first reference OBB, and the second smallest OBB as a second reference OBB (S102).

Next, the hit determination unit 58 extracts an OBB that is hit by the line of sight from among the OBBs that configure the provisional hit object (S104), and acquires the size of the object that includes that OBB (S106). When one object is configured by only one OBB, the size of the object corresponds to the size of that OBB. When one object is configured by a plurality of OBBs, the size of the object is assumed to be the size of the region that encompasses and circumscribes all of the OBBs, as described above.

Then, the hit determination unit 58 sets an object closest to the viewpoint as a first division candidate from among the objects that satisfy the division condition in comparison with the first reference OBB, such as the ratio of the size relative to the first reference OBB being equal to or greater than a predetermined value (S108). Furthermore, the hit determination unit 58 sets an object that is second closest to the viewpoint as a second division candidate among the objects that satisfy the division condition in comparison with the first reference OBB (S110). Note that in comparison with the first reference OBB, when there is only one object that satisfies the division condition, no object is set as the second division candidate in S110.

Referring to FIG. 30, next, the hit determination unit 58 determines the first division candidate object as a division target, on the condition that the first reference OBB set in S102 and the first division candidate object set in S108 are different (Y in S112, S114). In other words, when the first reference OBB is a part of the first division candidate object, at least at this stage, that object is not set as a division target. When the first reference OBB and the first division candidate object are the same (N in S112), when the hit determination unit 58 sets the second division candidate object in S110, the object is determined as a division target (Y in S116, S118).

When the second division candidate object has not been set (N in S116), the hit determination unit 58 compares the size of the second reference OBB set in S102 to the size of the first division candidate object set in S108. When the size of the first division candidate object satisfies the division condition, such as having a ratio of a predetermined value or more relative to the second reference OBB, the hit determination unit 58 determines the first division candidate as a division target (Y in S120, S122). When the first division candidate object does not satisfy the division condition in comparison to the second reference OBB, the hit determination unit 58 determines that there is no division target (N in S120, S124).

Note that the number of reference candidate OBBs and division candidate objects is not limited to two. In any case, by extracting a plurality of each, it is possible to check the size ratio by changing a combination of comparison objects. As a result, for example, even when a small OBB that configures a part of a large object is used as a reference and that object cannot be a division candidate, there is still room for division when comparing other combinations in the end. This configuration allows the OBB to be used as a basis for division necessity, regardless of granularity, and makes it possible to efficiently compare sizes and, ultimately, determine division necessity.

Note that in the illustrated procedure, as the process following N in S120, it is not checked whether the second division candidate object satisfies the division condition in comparison to the second reference OBB. This is because the second division candidate object that satisfies such a division condition also satisfies the division condition for the first reference OBB that is smaller than the second reference OBB, and therefore should be set as a division target in S118.

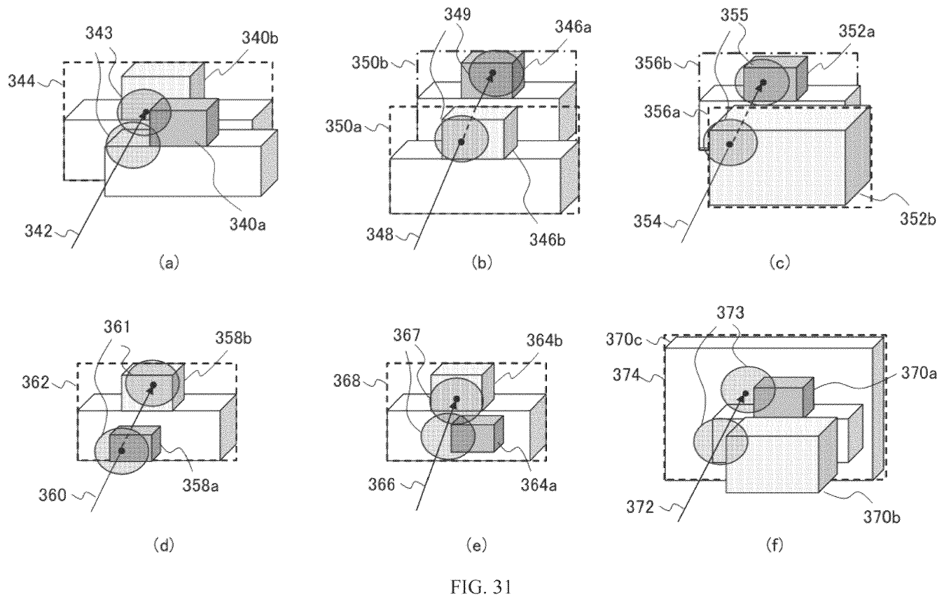

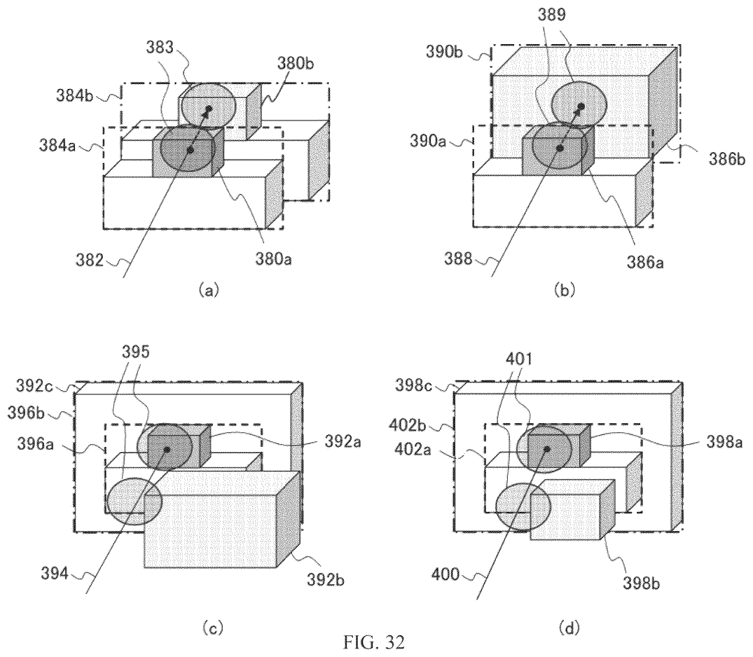

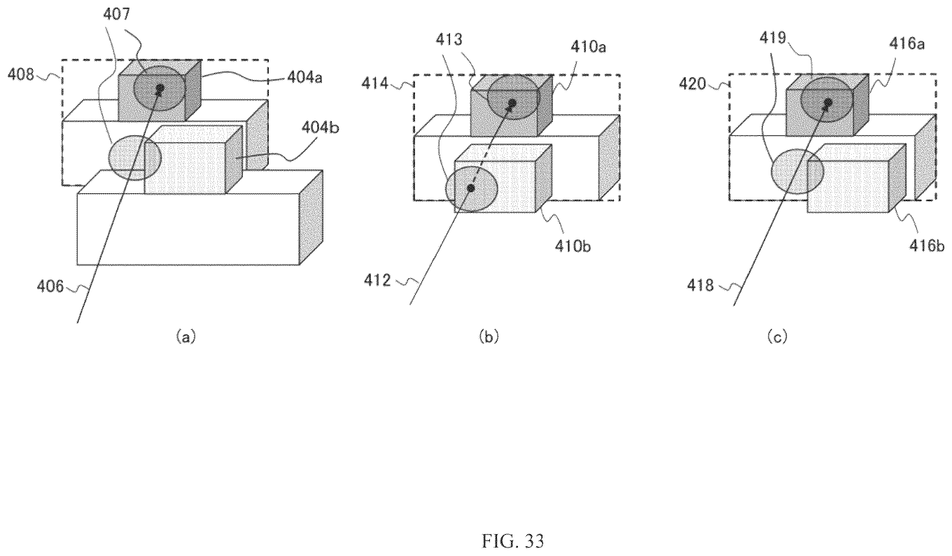

FIG. 31 illustrates an example of a case in which the first division candidate is set as a division target in S112 of the flowchart of FIG. 30. Note that in order to avoid complexity, in this figure, an object set as a division candidate that corresponds to one or a plurality of OBBs is represented by rectangles circumscribing the OBBs, but the actual object exists inside the OBBs and may have any shape. As mentioned above, the circumscribing rectangle is actually used to evaluate the size of the object. The same applies to FIGS. 32 and 33 described later.

In the state illustrated in (a), an OBB 340a, the smallest, and an OBB 340b, the second smallest, that are hit by a line of sight vector 342 or are within a margin region 343 are set as a first reference and a second reference, respectively. Also, the size of one object 344 including the OBB 340b that is hit by the line of sight vector 342 is acquired. When the size comparison to the first reference OBB 340a satisfies the division condition, the object 344 is set as the first division candidate. The first reference OBB 340a is not included in the first division candidate object 344, and therefore the object 344 becomes the division target.

In the state illustrated in (b), an OBB 346a, the smallest, and an OBB 346b, the second smallest, that are hit by a line of sight vector 348 or are within a margin region 349 are set as a first reference and a second reference, respectively. Furthermore, the OBBs 346b, 346a are hit by the line of sight vector 348, and the sizes of an object 350a including the former and an object 350b including the latter are acquired. When both objects 350a, 350b satisfy the division condition in comparison to the size of the first reference OBB 346a, the object 350a in the foreground is set as the first division candidate, and the further back object 350b is set as the second division candidate. In this case as well, the first reference OBB 346a is not included in the first division candidate object 350a, and therefore the object 350a becomes the division target.

In the state illustrated in (c), an OBB 352a, the smallest, and an OBB 352b, the second smallest, that are hit by a line of sight vector 354 or are within a margin region 355 are set as a first reference and a second reference, respectively. Furthermore, the OBBs 352b, 352a are hit by the line of sight vector 354, and the sizes of an object 356a including the former and an object 356b including the latter are acquired. When both objects 356a, 356b satisfy the division condition in comparison to the size of the first reference OBB 352a, the object 356a in the foreground is set as the first division candidate, and the further back object 356b is set as the second division candidate. In this case as well, the first reference OBB 352a is not included in the first division candidate object 356a, and therefore the object 356a becomes the division target.

In the state illustrated in (d), an OBB 358a, the smallest, and an OBB 358b, the second smallest, that are hit by a line of sight vector 360 or are within a margin region 361 are set as the first reference and the second reference, respectively. On the other hand, the OBBs 358a, 358b are hit by the line of sight vector 360, and the former alone corresponds to one object and is the first reference OBB itself, and so does not satisfy the division condition. When the size of the object 362 including the latter OBB 358b satisfies the division condition in comparison to the first reference OBB 358a, the object 362 is set as the first division candidate. The first reference OBB 358a is not included in the first division candidate object 362, and therefore the object 362 becomes the division target.

In the state illustrated in (e), an OBB 364a, the smallest, and an OBB 364b, the second smallest, that are hit by a line of sight vector 366 or are within a margin region 367 are set as a first reference and a second reference, respectively. Also, the size of one object 368 including the OBB 364b that is hit by the line of sight vector 366 is acquired. When the size comparison to the first reference OBB 364a satisfies the division condition, the object 368 is set as the first division candidate. The first reference OBB 364a is not included in the first division candidate object 368, and therefore the object 368 becomes the division target.

In the state illustrated in (f), an OBB 370a, the smallest, and an OBB 370b, the second smallest, that are hit by a line of sight vector 372 or are within a margin region 373 are set as a first reference and a second reference, respectively. Also, the size of an object 374 made up of only an OBB 370c that is hit by the line of sight vector 372 is acquired. When the size comparison to the first reference OBB 370a satisfies the division condition, the object 374 is set as the first division candidate. The first reference OBB 370a is not included in the first division candidate object 374, and therefore the object 374 becomes the division target.

FIG. 32 illustrates an example of a case in which the second division candidate is set as the division target in S116 of the flowchart of FIG. 30. In the state illustrated in (a), an OBB 380a, the smallest, and an OBB 380b, the second smallest, that are hit by a line of sight vector 382 or are within a margin region 383 are set as a first reference and a second reference, respectively. Furthermore, the OBBs 380a, 380b are hit by the line of sight vector 382, and the sizes of an object 384a including the former and an object 384b including the latter are acquired.

When both objects 384a, 384b satisfy the division condition in comparison to the size of the first reference OBB 380a, the object 384a in the foreground is set as the first division candidate, and the further back object 384b is set as the second division candidate. In this case, the first division candidate object 384a includes the first reference OBB 380a, and therefore does not become the division target due to the determination of S112 of FIG. 30. As a result, the object 384b, which is the second division candidate, becomes the division target.

In the state illustrated in (b), an OBB 386a, the smallest, and an OBB 386b, the second smallest, that are hit by a line of sight vector 388 or are within a margin region 389 are set as a first reference and a second reference, respectively. Furthermore, the OBBs 386a, 386b are hit by the line of sight vector 388, and the sizes of an object 390a including the former and an object 390b including the latter are acquired.

When both objects 390a, 390b satisfy the division condition in comparison to the size of the first reference OBB 386a, the object 390a in the foreground is set as the first division candidate, and the further back object 390b is set as the second division candidate. In this case, the first division candidate object 390a includes the first reference OBB 386a, and therefore does not become the division target due to the determination of S112 of FIG. 30. As a result, the object 390b, which is the second division candidate, becomes the division target.

In the state illustrated in (c), an OBB 392a, the smallest, and an OBB 392b, the second smallest, that are hit by a line of sight vector 394 or are within a margin region 395 are set as a first reference and a second reference, respectively. Furthermore, the OBBs 392a, 392c are hit by the line of sight vector 394, and the sizes of an object 396a including the former and an object 396b including the latter are acquired.

When both objects 396a, 396b satisfy the division condition in comparison to the size of the first reference OBB 392a, the object 396a in the foreground is set as the first division candidate, and the further back object 396b is set as the second division candidate. In this case, the first division candidate object 396a includes the first reference OBB 392a, and therefore does not become the division target due to the determination of S112 of FIG. 30. As a result, the object 396b, which is the second division candidate, becomes the division target.

In the state illustrated in (d), an OBB 398a, the smallest, and an OBB 398b, the second smallest, that are hit by a line of sight vector 400 or are within a margin region 401 are set as a first reference and a second reference, respectively. Furthermore, the OBBs 398a, 398c are hit by the line of sight vector 400, and the sizes of an object 402a including the former and an object 402b including the latter are acquired.

When both objects 402a, 402b satisfy the division condition in comparison to the size of the first reference OBB 398a, the object 402a in the foreground is set as the first division candidate, and the further back object 402b is set as the second division candidate. In this case, the first division candidate object 402a includes the first reference OBB 398a, and therefore does not become the division target due to the determination of S112 of FIG. 30. As a result, the object 402b, which is the second division candidate, becomes the division target.

FIG. 33 illustrates an example of a case in which the first division candidate is set as the division target due to the comparison to the second reference OBB in S120 of the flowchart of FIG. 30. In the state illustrated in (a), an OBB 404a, the smallest, and an OBB 404b, the second smallest, that are hit by a line of sight vector 406 or are within a margin region 407 are set as a first reference and a second reference, respectively. Also, the size of an object 408 including the OBB 404a that is hit by the line of sight vector 406 is acquired.

When the object 408 satisfies the division condition in the size comparison to the first reference OBB 404a, the object 408 is set as the first division candidate. In this case, the first division candidate object 408 includes the first reference OBB 404a, and therefore does not become the division target due to the determination of S112 of FIG. 30. Furthermore, since there is no second division candidate, the determination in S116 is also negative. As a result, when the first division candidate object 408 is compared in size to the second reference OBB 404b and fulfils the division condition, the object 408 becomes the division target.

In the state illustrated in (b), an OBB 410a, the smallest, and an OBB 410b, the second smallest, that are hit by a line of sight vector 412 or are within a margin region 413 are set as a first reference and a second reference, respectively. Furthermore, the OBBs 410b, 410a are hit by the line of sight vector 406, and the sizes of an object made up of only the former and an object 414 including the latter are acquired.

When only the object 414 satisfies the division condition in the size comparison to the first reference OBB 410a, the object 414 is set as the first division candidate. However, the first division candidate object 414 includes the first reference OBB 410a, and therefore does not become the division target due to the determination of S112 of FIG. 30. Furthermore, since there is no second division candidate, the determination in S116 is also negative. As a result, when the first division candidate object 414 is compared in size to the second reference OBB 410b and fulfils the division condition, the object 414 becomes the division target.

In the state illustrated in (c), an OBB 416a, the smallest, and an OBB 416b, the second smallest, that are hit by a line of sight vector 418 or are within a margin region 419 are set as a first reference and a second reference, respectively. Also, the size of an object 420 including the OBB 416a that is hit by the line of sight vector 418 is acquired. When the size comparison to the first reference OBB 416a satisfies the division condition, the object 420 is set as the first division candidate.

However, the first division candidate object 420 includes the first reference OBB 416a, and therefore does not become the division target due to the determination of S112 of FIG. 30. Furthermore, since there is no second division candidate, the determination in S116 is also negative. As a result, when the first division candidate object 420 is compared in size to the second reference OBB 416b and fulfils the division condition, the object 420 becomes the division target.

As indicated above, two OBBs acting as reference and two division candidate objects are prepared, and the combinations are changed to check whether the division condition is met. Here, the smallest OBBs acting as reference, and the division candidate objects closest to the viewpoint are prioritized and used for size comparison. Due to this, it is possible to appropriately divide easily selected large objects efficiently and to encompass various cases. Note that as illustrated in FIG. 13, it is desirable to determine the necessity of division of an object, taking into consideration not only the ratio of apparent areas but also the shapes of the reference OBB and other objects.

In order to estimate the approximate shape of an object, in the embodiment illustrated in FIG. 14, the object is projected onto a projection plane such as that illustrated in FIGS. 8 and 9, reference points are set on a contour of the projection, and an ellipse that approximates it is found. In this way, the aspect ratio of the object is determined, so measures may be taken, such as dividing a background object in the case of, for example, a long and thin object from which the line of sight is easily displaced. On the other hand, particularly in the case of an object made up of a plurality of OBBs, the shape becomes complex and an ellipse approximation may be difficult using simple calculations. Therefore, as a variation of the means for evaluating the size and shape of an object, the smallest rectangle that includes all of the OBBs that configure the object is generated.

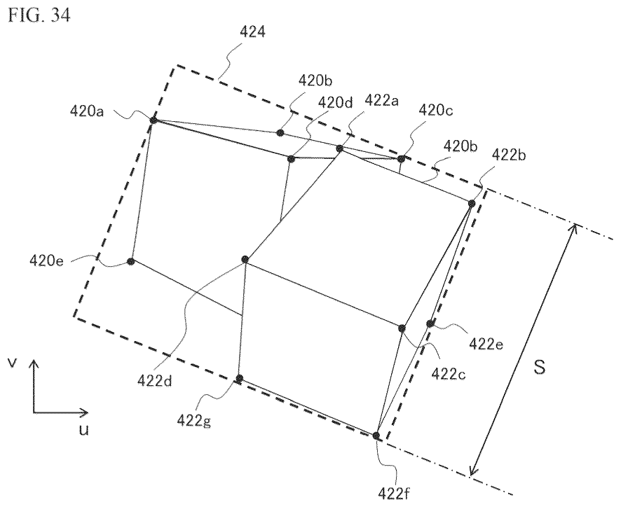

FIG. 34 is a diagram for describing a variation of a technique for estimating the size and shape of an object. In this aspect, the hit determination unit 58 projects the vertices of the OBB onto a projection plane such as a spherical surface centered on the viewpoint. The diagram illustrates a projection plane configured in a uv coordinate system. In this example, a state is illustrated in which an object made up of two OBBs is assumed, and vertex mappings 420a, 420b, 420c, 420d, 420e of one OBB and vertex mappings 422a, 422b, 422c, 422d, 422e, 422f, 422g of the other OBB are obtained. However, for ease of understanding, the diagram also illustrates edge mapping.

The hit determination unit 58 finds a rectangle 424 having the smallest area that encompasses all of these vertex mappings using a well-known technique. The derivation of the rectangle 424 is easier and less likely to be indefinite than the ellipse approximation illustrated in FIG. 14. When evaluating the ease of being hit by the line of sight, a length S of a short side of the rectangle 424 is used as an index instead of a length of the minor axis of the ellipse. Even when simply comparing sizes, the area and the like of the rectangle 424 may be used as an index of the size of the object.

### (Variation of Division Process)

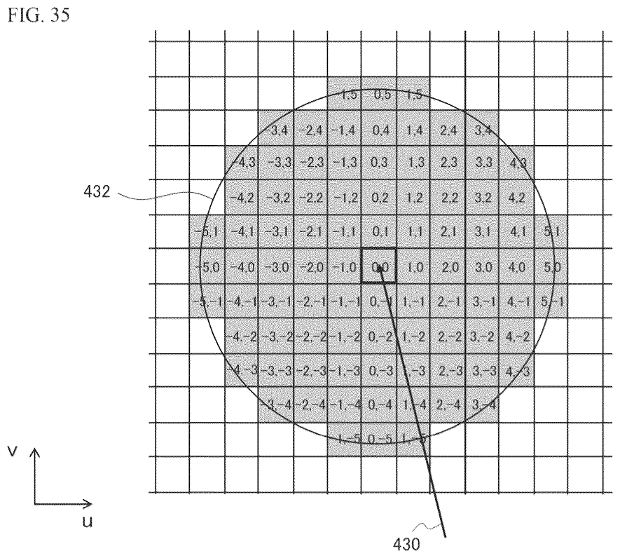

In the aspects illustrated in FIGS. 11 and 15, among division target objects, a surface which is hit by the line of sight vector is set as a provisional object, then directly divided. In the present variation, the surface of the division target object is projected onto the projection plane, and the projection is divided. FIG. 35 is a diagram for describing a technique for projecting a division target surface onto a projection plane and then dividing. The diagram illustrates a projection plane configured in a uv coordinate system. For example, the hit determination unit 58 performs a central projection of the division target surface onto a spherical surface of a predetermined radius with the viewpoint as the center.

Here, the hit determination unit 58 may improve the efficiency of processing in the same way as in the aspect illustrated in FIG. 15 by setting as the division target a region whose angle formed with a line of sight vector 430 is within a predetermined value. When the spherical surface centered on the viewpoint is set as the projection plane, a region 432 whose angle formed with the line of sight vector 430 is within a predetermined value becomes a circle of a predetermined radius centered on the intersection of the line of sight vector 430 on the projection plane. The hit determination unit performs division by limiting to a region within the region 432 in the mappings of the division target object. Furthermore, in the region 432 in the projection plane, for example, a dividing boundary is set evenly.

In the diagram, the dividing boundaries are represented by lines on a grid. Dividing the region 432 evenly means dividing the angle formed with the line of sight vector 430 evenly. The point in the region 432 where the line of sight vector 430 intersects is set as the origin (0, 0), and the position coordinates of each block after division are set appropriately as illustrated in the diagram. When the surface of the division target object is projected onto a projection plane having such a coordinate system, partial objects corresponding to each block will be formed. In other words, this technique makes it possible to keep the number of partial objects after division constant regardless of the actual size of the object, and makes it possible to stabilize a calculation load more than by dividing the object itself.

The hit determination unit 58 performs hit determination again on the mapping of the partial object thus formed, and finds the intersection of the line of sight vector 430, that is, the distance from the origin, and stores this in the distance data storage unit 62. For example, the hit determination unit 58 may project the surface of the division target object, and then set the distance from the center of the region 432 to each block as the distance from the line of sight vector 430 to the partial object. By defining a coordinate system on the projection plane where the intersection of the line of sight vector is set as the origin, the distance to each partial object may be easily acquired based on its position coordinates in that coordinate system.

Note that as illustrated in FIG. 9, when a determination of being inside or outside the margin region or an acquisition of the distance from the line of sight vector is performed on the projection plane, it is efficient to use the same projection plane during division. On the other hand, as described above, the selection determination unit 60 reads out past distance values stored in the distance data storage unit 62 by the hit determination unit 58, filters the distance value at the current time based on the trend, and then determines the selection target. Therefore, the hit determination unit 58 needs to acquire a history of distance values in association with partial objects obtained by dividing on the projection plane.

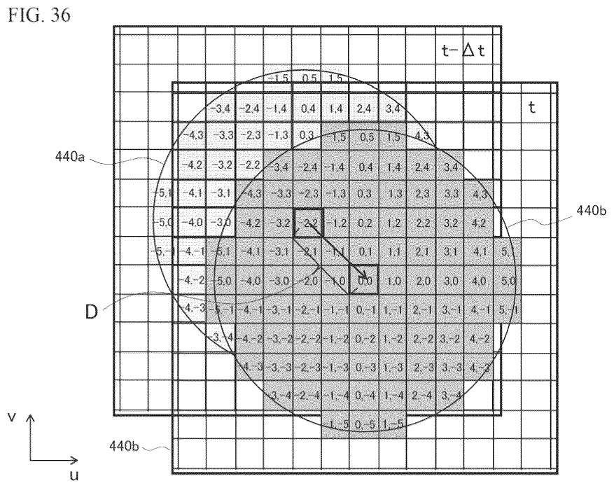

FIG. 36 is a diagram for describing a technique for acquiring a history of distance values for each partial object in an aspect of dividing objects on a projection plane. The diagram illustrates regions 440a, 440b of the mappings of the objects divided at a time t-Δt one previous and at a current time t in the uv coordinate system configuring the projection plane. Here, the time interval Δt is the frame generation period or the like. In this example, as indicated by the arrow, the line of sight vector moves downward and to the right on the projection plane from time t-Δt to time t.

At each time, an individual coordinate system is generated where the intersection of the line of sight vector is set as the origin, so that the individual coordinate system moves on the projection plane as the line of sight moves. Supposing the object is stationary, the relationship between the partial object and the individual coordinate system changes in response to this movement of the line of sight. For example, a partial object that was at the intersection of the line of sight vector at the time t-Δt comes to a location of coordinates (−2, 2) at the current time t. In this case, the distance history for the partial object is recorded as a distance of 0 for the time t-Δt and a distance of D for the time t. Here, the distance D corresponds to the distance from the origin to the coordinates (−2, 2).

Generalizing, when the movement amount of the intersection of the line of sight vector is (Δx, Δy), a partial object located at coordinates (x, y) at the current time t is at a location of coordinates (x+Δx, y+Δy) at the time t−Δt. Therefore, the hit determination unit 58 finds the distance D for the partial object located at the coordinates (x, y) at the current time t, and also finds the position coordinates (x+Δx, y+Δy) of the same partial object at the time t−Δt one previous, and stores the newly found distance D in the distance data storage unit 62 in correspondence with the record of the distance at that time.

By repeating this process, a distance history is recorded for each partial object. The selection determination unit 60 reads this out and filters as described in FIG. 25 to appropriately control the selection target. Note that even when the object moves without the line of sight moving, or when both the line of sight and the object move, the distance history for each partial object may be recorded using a similar calculation by finding the correspondence between coordinates from the amount of movement of each.

When the distance value for each partial object at the previous time t-Δt has not been recorded, such as for a surface that has become the division target for the first time, the hit determination unit 58 regards the distance value of the object before division at the previous time t-Δt as the distance value of the partial object at coordinates (0, 0) and associates this with the distance value of the partial object at the current time t. This allows for continuous filtering of the partial object.

For other partial objects, the distance value obtained at the current time t is used as the initial value, and filtering is performed using the values recorded thereafter. Furthermore, when an region that was not divided at the previous time t-Δt is newly divided due to a movement of the viewpoint, or the like, the hit determination unit 58 sets the distance value obtained at the current time t as the initial value and performs filtering using the values recorded thereafter. The present variation makes it possible to efficiently redo hit determination and derive distance values at a constant calculation load, regardless of circumstances such as the size of the object. As a result, object selection by line of sight may be performed with stable responsiveness.

### (Variation of Hit Object Detection Process)

In the embodiments described so far, the hit determination unit 58 has set a positional relationship with the line of sight vector as the highest priority basis, and for example, set as the hit object an object having predominance, such as an object nearest the line of sight vector and in the foreground. In other words, when there is an object that sufficiently satisfies the condition in relation to the line of sight vector, the possibility that other objects will be set as the hit object, and therefore the possibility that will be set as the selection target, will be reduced.

In the present variation, even when there is another object hit by the line of sight vector, an object having a high possibility that the user is aligning the line of sight remains as a detection candidate. Note that in the following description, the unit of hit detection is referred to as an “object,” but this unit may be a partial object after division, or may be an OBB configuring an object.

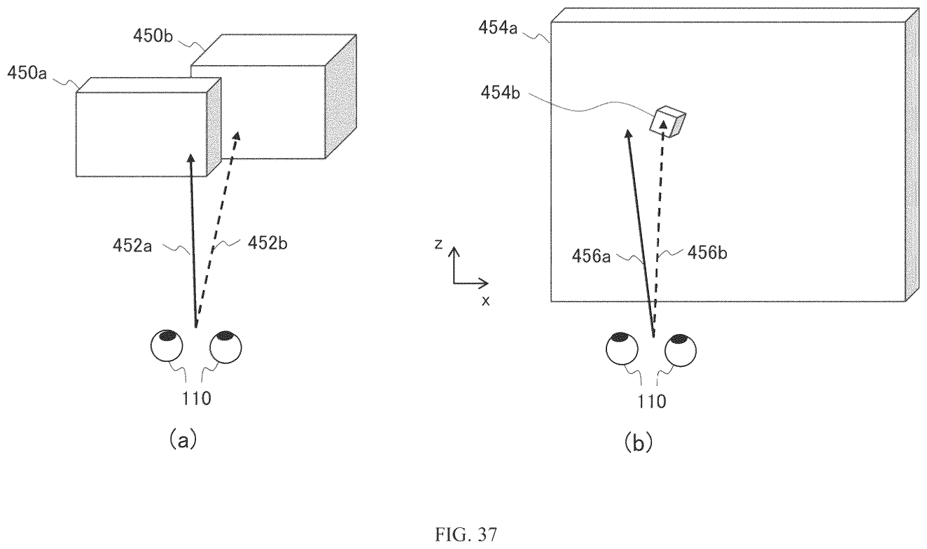

FIG. 37 illustrates an example of a case where another object is set as the hit object even when the user tries to align the line of sight. In the example of (a), objects 450a, 450b of approximately the same size are located adjacent to each other. It is assumed that the user is aligning the line of sight with the object 450b from a viewpoint 110. However, for example, when detection error of the line of sight vector is large, a line of sight vector 452a that is deviated from the actual line of sight vector 452b may be detected. Then, the hit determination unit 58 determines that the object 450a, which is hit by the line of sight vector 452a and is in the foreground is the hit object. As a result, the object 450b, which should have been determined to be the hit object, is excluded from targets for comparison by the selection determination unit 60.

In the example of (b), a small object 454b is located in front of a large area object 454a such as a wall. As in (a), even when the actual line of sight vector is a line of sight vector 456b, when a detection error results in a deviated line of sight vector 456a being detected, the hit determination unit 58 determines that the object 454a is the hit object. As a result, the object 454b, which should have been determined to be the hit object, is excluded from targets for comparison by the selection determination unit 60.

Such erroneous detection of a hit object may occur not only due to a detection error of line of sight but also depending on movement characteristics of the line of sight of the individual user and the like. For example, when the object 454b is small or moving, a user whose line of sight tends to waver may find it difficult to match the line of sight on a small object 455b, even when a large area object 454a is divided, and may have difficulty selecting it.

Taking such a situation into consideration, in order to further increase selection accuracy using line of sight, the hit determination unit 58 leaves open the possibility that the objects 450b, 454b will be set as the hit object. That is, the hit determination unit 58 not only sets an object that has predominance in the positional relationship between the line of sight vector and the target as the hit object, but also sets another object that has predominance in the correlation of movement with the line of sight vector as a candidate for the hit object.

More specifically, when an object is moving, the hit determination unit 58 evaluates the possibility that the line of sight is aligned on it from the length of the accumulated time that the object has been in the margin region, and when the possibility is high, it is set as a candidate for the hit object. This process is performed after the hit object is determined in the hit object detection process illustrated in FIG. 5, or in parallel with the detection of the hit object.

Once a candidate for the hit object has been detected separately in this manner, the hit determination unit 58 compares the hit object determined in the hit object detection process illustrated in FIG. 5 with the candidate for the hit object determined in the present variation, and sets the one having a higher possibility of the line of sight aligning as the final hit object. In the following description, a hit object that has predominance in the positional relationship between the line of sight vector and the target, as detected in the procedure of FIG. 5, will be referred to as a “standard hit object.” Furthermore, in the present variation, a hit object candidate that is additionally determined and has predominance in correlation with the line of sight vector in movement is called a “deemed hit object.”

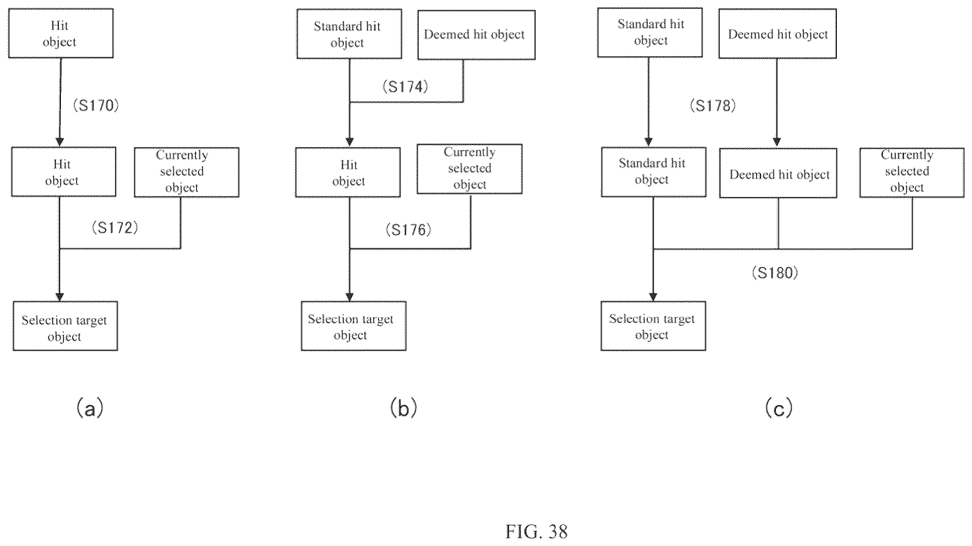

FIG. 38 compares a selection procedure of objects when a detection process of a deemed hit object is not introduced and when such is introduced. (a) is the procedure when no deemed hit object is introduced. In this case, the hit determination unit 58 basically detects one hit object, that is, a standard hit object, and notifies the selection determination unit 60 (S170). The selection determination unit 60 compares the notified hit object with the currently selected object, and, for example, determines the final selection target object based on proximity to the line of sight vector or the like (S170).
(b) is a procedure when a deemed hit object is introduced. In this case, the hit determination unit 58 detects the deemed hit object as described above, separately from the standard hit object. The hit determination unit 58 then further evaluates the possibility that the user is aligning the line of sight on the deemed hit object, thereby determining one of them as the final hit object and notifying the selection determination unit 60 (S174). Similarly to (a) the selection determination unit 60 compares the notified hit object with the currently selected object, and determines the final selection target object (S176).
(c) is a variation of (b) when a deemed hit object is introduced. That is, the hit determination unit 58 detects the deemed hit object separately from the standard hit object, but does not select one of them, and notifies the selection determination unit 60 of information on both (S178). The selection determination unit 60 compares the standard hit object and the deemed hit object with the currently selected object, and, for example, determines the final selection target object based on proximity to the line of sight vector or the like (S180). Even in this way, the possibility may be left that the deemed hit object will be selected.

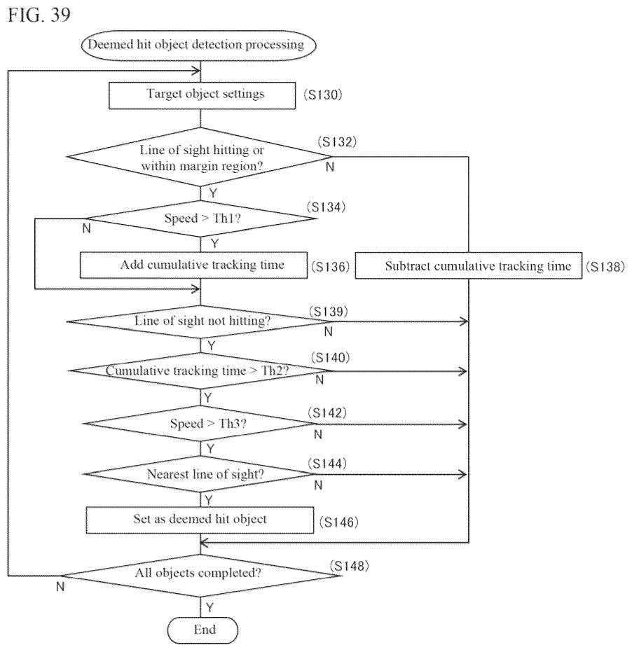

FIG. 39 is a flowchart illustrating a processing procedure in which the hit determination unit 58 detects the deemed hit object. First, the hit determination unit 58 sets one of the objects present in the image world as a target object (S130), and checks whether the line of sight vector is hitting the object or whether it is within the margin region (S132). This process may utilize the provisional hit object detection results obtained in the course of the hit object detection process illustrated in FIG. 5.

When the line of sight vector hits the target object or is within the margin region (Y in S132), the hit determination unit 58 adds a unit time to an “cumulative tracking time” associated with the target object, provided that the speed of the object exceeds a threshold value Th1 (Y in S134, S136). Here, the “cumulative tracking time” is the total time spent at least in the margin region of the line of sight for an object moving at a speed exceeding a threshold value.

When the cumulative tracking time is long, the possibility is high that the user is tracking a moving object with their eye. In other words, in the present variation, the possibility that the user is aligning the line of sight on an object is evaluated based on the total time that the moving object is at least in the margin region. Here, by using the cumulative time instead of the consecutive time, the time is not reset even when the margin region is temporarily left. Furthermore, the “unit time” to be added to the cumulative tracking time may, for example, be an elapsed time from the previous process, such as the frame generation cycle or the line of sight detection cycle.

Even when the line of sight vector hits the target object or is within the margin region, the hit determination unit 58 does not add a unit time to the cumulative tracking time, when the speed of the object is a equal to or less than the threshold value Th1 (N in S134). When the target object is outside the margin region (N in S132), the hit determination unit 58 subtracts a unit time from the cumulative tracking time (S138). This allows the cumulative tracking time to be reduced for objects that are clearly out of the line of sight, improving accuracy as an index of the possibility of line of sight aligning.

Note that when the speed of the object is equal to or less than the threshold value Th1 in S134, the possibility that the user is aligning the line of sight cannot be denied, and therefore the accumulated time is left as it is. Furthermore, the cumulative tracking time may be the total time that satisfies the above condition during the most recent predetermined time. The hit determination unit 58 further sets the target object as the deemed hit object (S146) on the conditions that the line of sight vector does not hit the target object (Y at S139), the latest cumulative tracking time exceeds a threshold value Th2 (Y at S140), a speed of the target object exceeds a threshold value Th3 (Y at S142), and the target object is closest to the line of sight vector (Y at S144).

When the line of sight vector hits the target object, the target object is evaluated in the hit object detection process illustrated in FIG. 5 and may be set as the hit object in some cases, so it is not included in the deemed hit objects. Furthermore, as mentioned above, the cumulative tracking time indicates the possibility that the user is tracking the object with their eye, and when it exceeds a threshold value, it can be said that the object is appropriate as a deemed hit object. Furthermore, when the speed of the target object at the current time is slower than the threshold value Th3 or if it is stationary, it is not included in deemed hit objects because the predominance of probability of the line of sight aligning cannot be measured in comparison with other stationary objects.

The condition of being closest to the line of sight vector is a measure taken when there is a plurality of objects that satisfy S139, S140, and S142. That is, when another object has been set as the deemed hit object, a comparison is made therewith, and when the current target object is closer to the line of sight vector, the deemed hit object is updated to that target object. When at least one of the conditions of S139, S140, S142, and S144 is not fulfilled, the hit determination unit 58 does not set the target object as the deemed hit object (S139 N, N in S140, N in S142, N in S144).

When evaluation has not been completed for all objects, the hit determination unit 58 sets another object as the target object (S130) and repeats the processes of S132 to S146. When evaluation of all objects is completed, the hit determination unit 58 terminates the deemed hit object detection process. This process will result in either one deemed hit object being detected or nothing being detected. Note that the evaluation criteria of S139, S140, S142, and S144 are merely examples, and the hit determination unit 58 may perform at least one of them, or may introduce a separate evaluation criterium.

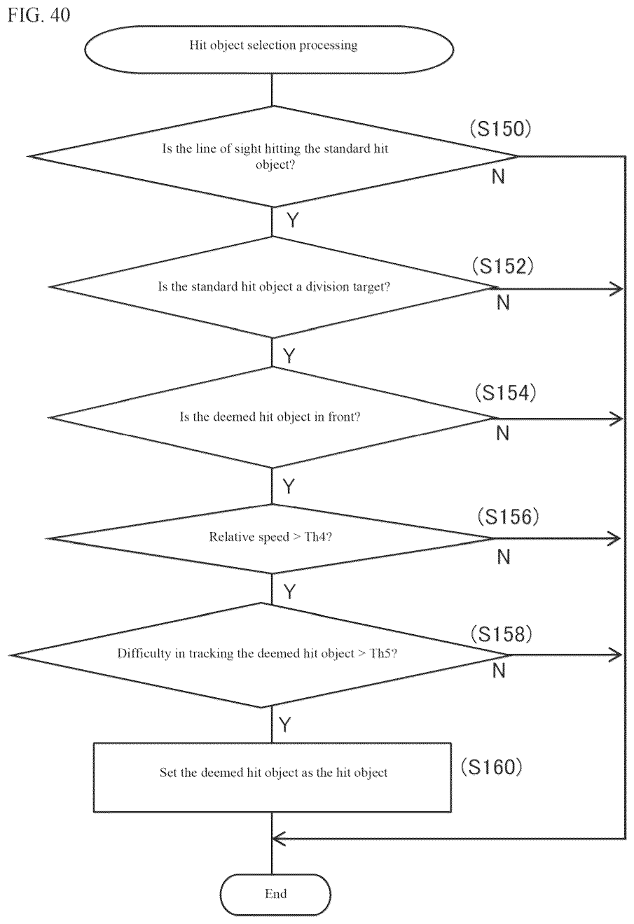

FIG. 40 is a flowchart illustrating a processing procedure in which the hit determination unit 58 selects the final hit object when the deemed hit object is detected. Although the figure illustrates an aspect in which a plurality of evaluations are implemented in order, the order is not particularly limited since all the evaluations are based on independent criteria, and may be performed in parallel at the same time.

In this example, the hit determination unit 58 selects the deemed hit object as the final hit object (S160) when all of the following are fulfilled: the line of sight vector hits the standard hit object (Y in S150), the standard hit object is the division target (Y in S152), the deemed hit object is in front of the standard hit object (Y in S154), the relative speed of the deemed hit object having the standard hit object as a reference exceeds a threshold value Th4 (Y in S156), and the parameter representing the difficulty of tracking the deemed hit object exceeds a threshold value Th5 (Y in S158).

In order to exclude the standard hit object detected under the original condition and select the deemed hit object as the hit object, sufficient basis is required, so various conditions are imposed as illustrated in the diagram. However, it is not intended to limit the conditions to these. Qualitatively, the hit determination unit 58 sets the deemed hit object as the final hit object when the deemed hit object is relatively less likely to be hit by the line of sight than the comparison target standard hit object. This is because when a moving object is near the line of sight vector for a set cumulative time or more regardless of being difficult for the line of sight to hit, it is considered to be highly possible that the user is intentionally following it with the eye.

The evaluation in S150 checks that the standard hit object and the deemed hit object are not identical. That is, in S139 of FIG. 39, not being hit by the line of sight vector is a condition for the deemed hit object. Therefore, when the line of sight vector hits the standard hit object, it is known that the deemed hit object is not the standard hit object.

The evaluation in S152 checks the ease of the line of sight vector hitting the standard hit object. That is, as illustrated in FIG. 37(b), when a standard hit object is large enough to be a division target, a situation is inferred in which even when a user follows the deemed hit object with the eye, the line of sight may accidentally hit the standard hit object. That is, it can be said that the deemed hit object is relatively difficult to align with the line of sight, so even when the line of sight does not hit it, there is a high probability that it should actually be set as the hit object.

The evaluation in S154 also assumes a small deemed hit object existing in front of a large area standard hit object, as illustrated in FIG. 37(b). In this case as well, as in the evaluation in S152, a situation is inferred in which the line of sight accidentally hits the standard hit object, and therefore it is highly valid to set the deemed hit object as the hit object. Regarding the evaluation in S156, when the standard hit object and the deemed hit object are moving in substantially the same way, the predominance of probability of the line of sight aligning cannot be measured between the two, and therefore the deemed hit object is not set as the hit object.

The evaluation in S158 takes into consideration the size and speed of the deemed hit object in the movement direction, and checks how difficult it is to track the deemed hit object. As described above, the more difficult tracking is, the more valid it is to set the deemed hit object as the hit object. Details will be provided below. When at least one of the conditions of S150, S152, S154, S156, and S158 is not fulfilled, the hit determination unit 58 does not set the deemed hit object as the final hit object (N in S150, N in S152, N in S154, N in S156, S158). In this case, the standard hit object becomes the final hit object. Note that the evaluation criteria of S150, S152, S154, S156, and S158 are merely examples, and the hit determination unit 58 may perform at least one of them, or may introduce a separate evaluation criterium.

In the process illustrated in FIGS. 39 and 40, various parameters are subjected to threshold determination. In order to mitigate the adverse effects of introducing a deemed hit object, it is necessary to find an appropriate threshold value, either fixed or variable, taking into account various circumstances. For example, as illustrated in FIG. 37(b), when trying to select a small object in front of a large area object using the line of sight, it becomes difficult to follow using the line of sight, especially when the small object is moving, and the probability of selecting the large area object increases. Therefore, it is desirable to lower the threshold value for speed and the threshold value for cumulative tracking time and the like, and to relax the conditions.

On the other hand, when the threshold value for the speed of the object is small, the deemed hit object is more easily set as the final hit object. In this case, for example, in a configuration where a plurality of similar objects are lined up in the margin region, it is not possible to measure the predominance of probability of the line of sight aligning between those objects, and the selection target may switch one after another. Also, when the threshold value for the cumulative tracking time is small, the deemed hit object may be replaced one after another.

When the threshold value for the relative speed of the deemed hit object to the standard hit object is too small, in a case where there is a plurality of objects moving in the same way, when the objects in the margin region are frequently replaced, the hit object will also switch accordingly. Generally speaking, when these thresholds are too small, there is a high possibility that an object that should not originally be determined as hit will be set as the hit object. When the thresholds are too large, the deemed hit object itself will be difficult to detect. Therefore, as preliminary preparation, an experiment is carried out using test images and the like with various changes in the size, movement and arrangement of the objects, and the threshold values are optimized for each situation and then stored in the internal memory of the hit determination unit 58.

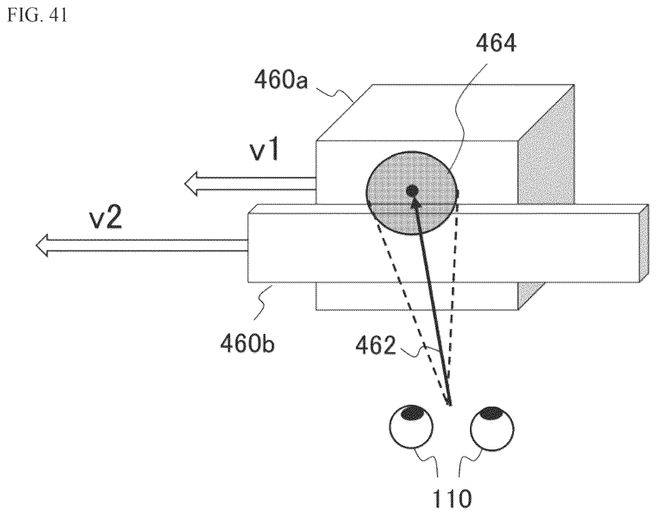

FIG. 41 is a diagram for describing a principle for quantifying a difficulty of tracking a deemed hit object, which is checked in S158 of the flowchart of FIG. 40. In the diagram, a horizontally long object 460b is illustrated positioned in front of a cube-shaped object 460a. Furthermore, as indicated by the white arrows, both are moving leftward, and the velocities of the objects 460a, 460b are v1 and v2 (v2>v1), respectively. Here, it is assumed that the user is following the object 460a located in the back from the viewpoint 110 with the eye.

As a result, when a line of sight vector 462 hits the object 460a, the object 460a becomes the standard hit object. On the other hand, since the front object 460b is in a margin region 464, when the velocity v2 is greater than the threshold value, the cumulative tracking time for the object 460b is added in accordance with the state illustrated in the diagram. On the other hand, when the object 460b has a shape that is long in the direction of movement, an overlap with the object 460a is maintained for a long period during movement. As a result, the object 460b continues to be in the margin region 464, and the cumulative tracking time becomes longer, so that the possibility of being set as the deemed hit object increases.

In other words, in this case, when evaluation is only using velocity and cumulative tracking time, the object 460b is likely to have an advantage in the hit determination, and in some cases it may be possible to set as the final hit object instead of the object 460a. Therefore, in the present variation, the difficulty of tracking the deemed hit object is added to the evaluation, and the object 460b that has a property of easily entering the margin region, as illustrated in the diagram, does not easily become the hit object. As a result, the object 460a that was originally hit by the line of sight vector is set as the hit object, and more accurate selection may be realized.

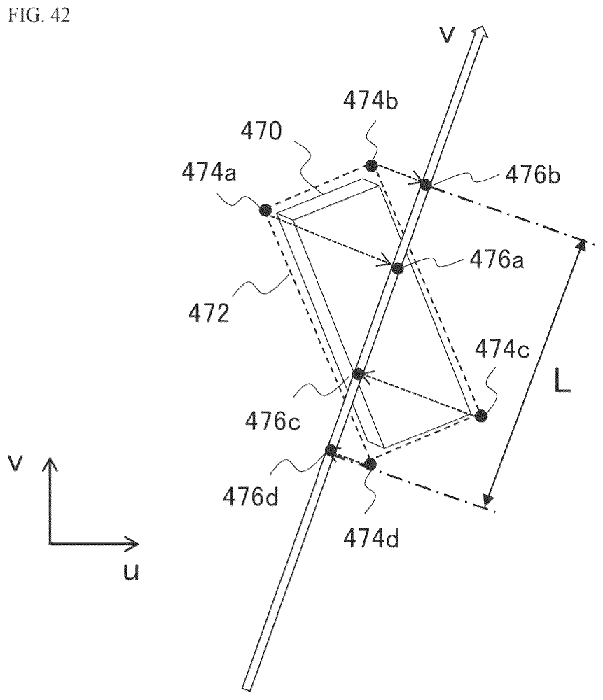

FIG. 42 is a diagram for describing a calculation technique for a parameter representing a difficulty in tracking a deemed hit object. In the illustrated example, a deemed hit object 470 is moving with a velocity vector v in the direction of the white arrow. The hit determination unit 58 acquires a component of the size of the deemed hit object 470 in the direction of the velocity vector v. Like the object 460b in FIG. 41, the larger the size of the deemed hit object in the velocity vector direction, the higher the possibility that it will be in the margin region of the line of sight for a long period. As a result, the deemed hit object is more likely to be determined as being tracked, regardless of whether the user intends to. In the present embodiment, the ease of this determination is expressed as “ease of tracking.”

Note that in the diagram, the object 470 has a rectangular parallelepiped shape, but this is merely an example. That is, the object 470 may be an object of any shape, or may be substituted with one or a plurality of OBBs that configure the object. Furthermore, the detection technique of the deemed hit object described above naturally require that the movement be recognized by the user, so movement in the line of sight direction does not need to be taken into account. Therefore, the illustrated calculations may be performed in a two-dimensional space formed by projecting onto a projection plane such as a spherical surface centered on the viewpoint. The diagram illustrates a state in which the deemed hit object 470 and the velocity vector v are projected onto a uv coordinate system that configures the projection plane.

The hit determination unit 58 first generates a rectangle 472 of a minimum area that circumscribes the mapping of the deemed hit object 470. The technique described with reference to FIG. 34 may be applied to this process. The hit determination unit 58 then projects vertices 474a, 474b, 474c, and 474d of the generated rectangle 472 onto a straight line that is a mapping of the velocity vector v. Of four points 476a, 476b, 476c, and 476d formed by projection, a distance L between the two points 476b, 476d at extremes represents the component of the velocity vector direction of the size of the deemed hit object 470. As described above, the hit determination unit 58 sets a parameter L as an index representing the ease of tracking the object 470.

The difficulty of tracking the deemed hit object is proportional to the inverse of an index L. The difficulty of tracking also depends on the speed of the object. In other words, when the speed is high, tracking is difficult, and when the speed is low, tracking is easy. Therefore, the hit determination unit 58 defines an index X of difficulty of tracking a deemed hit object using the velocity |v| and the index L of ease of tracking as follows.

$$X = \vert v \vert / L$$

where, when the velocity |v| and L are divided into cases where they are greater than a predetermined value and cases where they are smaller than a predetermined value, the relationship between these parameters and the index X is as follows.

TABLE 1

| | | Velocity \|V\| | |
|---|---|---|---|
| | | small | large |
| index L | small | medium | 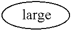 |
| | large | small | medium |

For example, the index L of object 460b illustrated in FIG. 41 is large, so even when the velocity |v| is large, the index X of the difficulty of tracking does not become large. Even when the index L is small, when the velocity |v| is small, the index X will have a medium value. When the index L is small and the velocity |v| is large, the index X becomes large as encircled by the oval in the table. A situation where the index L is small is not limited to a case where the object is long in the direction perpendicular to the velocity vector, but may also include a case where the object is small overall. For example, when a small square object is randomly walking at high speed, the index X becomes large. When the random walk of the object is about to stop, the velocity |v| decreases, and therefore the index X also decreases.

Taking the above into account, an appropriate threshold value Th5 is set for the index X of the difficulty of tracking the deemed hit object in order to distinguish between the “large” state in the table and other states. Then, in S158 of the flowchart illustrated in FIG. 40, the hit determination unit 58 sets the deemed hit object as the final hit object only when the index X exceeds the threshold value Th5.

Note that the smaller the velocity of the object, the more likely the velocity vector is to become unstable, and therefore the accuracy of the index L, and thus the accuracy of the index X, will decrease. Therefore, preferably, as a detection condition for the deemed hit object, the threshold value Th3 given to the velocity in S142 of FIG. 39 is set within a range in which the velocity vector is stable. This enables the index X to be obtained at stable accuracy, and appropriately determine whether to set the deemed hit object as the hit object.

According to the present embodiment described above, in a system in which selection input is performed using line of sight, it is determined whether the line of sight is hitting based on the positional relationship between a margin region that is adaptively expanded around the detected line of sight vector and the selection target object. In this way, the effects on determination results from external factors such as the accuracy of line of sight detection, line of sight fluctuation characteristics, and object movement may be reduced.

Furthermore, when an object is determined to be hit by the line of sight, predominance in terms of the time it has been hit by the line of sight and its predominance in terms of its proximity to the line of sight are evaluated from multiple angles to finally determine whether to set as the selection target. In this way the margin region is set in the hit detection, and even when the conditions for determining a hit are relaxed, it is possible to carefully set an object having a high possibility of the user intentionally aligning the line of sight as the selection target. Note that a determination of a selection target based on such a multiple angle evaluation exhibits a large effect on improving the determination accuracy of a selection target, even when no margin region is set in the hit detection.

Furthermore, when there is another object behind an object and the area ratio of the latter is larger than that of the former, hit detection is performed and determination of a selection target in units of partial objects formed by dividing the object. By making the apparent sizes of a plurality of objects in the vicinity of the line of sight vector uniform, the ease of the line of sight hitting on the determination may be made equal, and it is possible to prevent a situation where a large object such as a rear wall is unintentionally selected and a front object that is actually desired for selection always remains unselected. As described above, according to the present embodiment, determination of the selection target based on the line of sight may be performed stably and at high accuracy. As a result, the user may easily select a target desired for selection.

Furthermore, this also allows introducing OBBs instead of objects. This makes it easier to estimate the size of even complexly shaped objects, and makes it possible to more efficiently determine division necessity of an object. In determining division necessity, an OBB that is used as a size reference and a plurality of division candidate objects are extracted, and evaluation is performed by switching between comparison targets, thereby enabling accurate detection of large objects that should be divided.

When dividing an object, the object is projected onto a projection plane such as a spherical surface centered on the viewpoint, and the mapping is then divided. This makes it possible to always generate the same number of partial objects having the same apparent area regardless of the size or inclination of the object, and to stabilize the calculation load for division. Furthermore, when determining whether an object is inside or outside the margin region or acquisition of the distance from the line of sight vector is performed on the projection plane, the same projection plane may also be used for the division process, further improving efficiency.

Furthermore, an object that is not hit by the line of sight vector but with which the user is trying to align the line of sight is estimated based on the state of tracking of the moving object. This suppresses the overlooking of objects for which hit determination is difficult due to error in line of sight detection, characteristics of each user's line of sight movement, the shape and movement of the object, and reliance on a relationship with other objects, and the like, whereby selection accuracy may be improved.

The above is a description of the present disclosure based on an embodiment. The embodiment is an example, and it is understood by those having ordinary skill in the art that various variations are possible in the combination of their respective constituent elements and respective processing processes, and that such variations are also within the scope of the present disclosure.

### INDUSTRIAL APPLICABILITY

As described above, the present disclosure can be used in information processing devices such as game devices, content processing devices, and personal computers, as well as information processing systems including any of these.

### DESCRIPTION OF REFERENCE NUMERALS

10 information processing device, 12 line of sight detector, 16 display device, 23 CPU, 26 main memory, 50 selection target determination unit, 52 information processing unit, 54 display image generation unit, 56 line of sight information acquisition unit, 58 hit determination unit, 60 selection determination unit, 62 distance data storage unit.

What is claimed is:

1. An information processing device comprising:
one or more storage devices storing instructions; and
one or more processors, that upon execution of the instructions, configured to:
acquire information on a line of sight vector of a user;
detect a selection candidate based on a positional relationship between the line of sight vector and a target; and
determine whether to make the selection candidate a selection target based on conditions according to a selection situation at the time the selection candidate is detected.

2. The information processing device of claim 1, wherein, in a situation where there is a currently selected target, the one or more processors are configured to switch the selection target to the selection candidate when a distance from the line of sight vector is shorter than that of the currently selected target.

3. The information processing device of claim 2, wherein the one or more processors are configured to store a history of distance values from the line of sight vector for each target in the one or more storage devices, and
wherein, using the history, the one or more processors are configured to compare distance values obtained by applying a smoothing filter to changes in distance values from the line of sight vector between the currently selected target and the selection candidate.

4. The information processing device of claim 3, wherein the one or more processors are configured to change a strength of the smoothing filter depending on a content of information processing using the selection result.

5. The information processing device of claim 4, wherein the one or more processors are configured to change a temporal condition for determining whether to make the selection candidate a selection target, depending on the strength of the smoothing filter.

6. The information processing device of claim 3, wherein the one or more processors are configured to set a period in which the line of sight vector is not detected as a blinking period, and when the period is equal to or greater than a predetermined value, exclude data of distance values before a blink from being subject to filtering.

7. The information processing device of claim 1, wherein the one or more processors are not configured to set the selection candidate as the selection target when a persistence time of a state in which the same selection candidate is not set as the selection target is equal to or less than a predetermined value t1, and sets the selection candidate as the selection target when the persistence time is equal to or greater than a predetermined value t3 (where t3>t1).

8. The information processing device of claim 7, wherein the one or more processors are configured to set the selection candidate as a selection target when the persistence time of a state in which the same selection candidate is not set as a selection candidate is greater than the t1 and less than the t3, and when a proportion of time during which the selection candidate was detected in the most recent predetermined period is equal to or greater than a predetermined value.

9. The information processing device of claim 7, wherein the one or more processors are configured to maintain a selected state of the currently selected target when there is a currently selected target and the persistence time of a state in which the selection candidate is not detected is equal to or less than a predetermined value t2 (where t2>t1).

10. The information processing device of claim 1, wherein the one or more processors are configured to set a period in which the line of sight vector is not detected as a blinking period, and keep the selection target during the blinking period and for a predetermined time thereafter.

11. The information processing device of claim 1, wherein the one or more processors are configured to acquire three-dimensional position coordinates of a gaze point based on a line of sight vectors of each of a left and right eye in a three-dimensional space in which the target exists, and switch the selection target to the selection candidate when the selection candidate is within a predetermined range from the gaze point.

12. The information processing device of claim 1, wherein the one or more processors are configured to detect a first target that has predominance in a positional relationship between the line of sight vector and the target, and a second target that has predominance in a correlation of movement with the line of sight vector, and further configured to compare the first target and the second target to determine the selection candidate.

13. The information processing device of claim 1, wherein the one or more processors are configured to detect a first target that has predominance in terms of the positional relationship between the line of sight vector and the target, and a second target that has predominance in terms of a correlation of movement with the line of sight vector, and
wherein the one or more processors are configured to determine the target to be the selection target by comparing at least the first target and the second target.

14. The information processing device according to claim 12, wherein the one or more processors are configured to set a margin region of a predetermined range based on the line of sight vector, and detect as the second target a target in a state having a speed exceeding a predetermined threshold and whose cumulative time of being in the margin region exceeds the predetermined threshold.

15. The information processing device of claim 14, wherein the one or more processors are configured to detect the second target when the target is moving at a speed exceeding a predetermined threshold value at the time of the detection process.

16. The information processing device of claim 12, wherein the one or more processors are configured to quantify a difficulty of tracking the second target based on a magnitude of the velocity vector direction and the velocity of the second object, and configured not to set the second target as the selection candidate when the quantified difficulty is equal to or less than a predetermined threshold value.

17. The information processing device of claim 16, wherein the one or more processors are configured to project the second target and the velocity vector onto a spherical surface of a predetermined radius centered on a viewpoint, and evaluates the size of the velocity vector direction on the spherical surface.

18. The information processing device of claim 12, wherein the one or more processors are configured not to set the second target as the selection candidate when the first target does not fulfil a predetermined condition indicating that an apparent size is large.

19. The information processing device of claim 12, wherein the one or more processors are configured not to set the second target as the selection candidate when the first target is closer or at a same distance to the viewpoint than the second target.

20. The information processing device of claim 12, wherein the one or more processors are configured not to set the second target as the selection candidate when a relative speed of the second target to the first target is equal to or less than a predetermined threshold value.

21. An information processing method, comprising:
acquiring information on a line of sight vector of a user;
detecting a selection candidate based on a positional relationship between the line of sight vector and a target; and
determining whether to make the selection candidate a selection target based on conditions according to a selection situation at the time the selection candidate is detected.
